(19) United States
(12) Patent Application Publication
(10) Pub. No.: US 2008/0201171 A1
(43) Pub. Date: Aug. 21, 2008

(54) PATIENT NOTIFICATION SYSTEM AND METHOD

(76) Inventor: STEVEN D. BRUSHWOOD, St. Joseph, MO (US)

Correspondence Address: INTELLECTUAL PROPERTY CENTER, LLC, 9233 WARD PARKWAY, SUITE 100, KANSAS CITY, MO, 64114, US

(21) Appl. No.: 12/034,535

(22) Filed: Feb. 20, 2008

Related U.S. Application Data
(60) Provisional application No. 60/902,292, filed on Feb. 20, 2007.

(51) Int. Cl. G06Q 50/00

(52) U.S. Cl. 705/2

(57) ABSTRACT

In the practice of the present invention, a method and system for notifying a patient of a medical office about a pharmaceutical event based upon a pharmaceutical sample associated with the patient and corresponding to received event data, said patient selected from a list of patients retrievably stored within a database, a message being generated by the computer in response to said pharmaceutical event and transmitted to the patient. In addition, the present invention allows the medical office to monitor drug sample inventory and record dispensed drug samples and newly received drug samples. Optionally, the system may selectively transmit a portion of the medical office database to a pharmaceutical company for monitoring the inventory, dispensing and utilization of selected drug samples at plural medical offices.

### CROSS-REFERENCE TO RELATED APPLICATION

This application claims the benefit of the prior filed U.S. provisional application No. 60/902,292 filed Feb. 20, 2007 which is incorporated herein by reference.

### BACKGROUND OF THE INVENTION

1. Field of the Invention

The present invention relates generally to a system for notifying a medical office and a medical office patient of a pharmaceutical event related to a pharmaceutical sample. The patients each having a unique identifier are retrievably recorded by the system and associated with a dispensed pharmaceutical sample, also having a sample identifier. In addition, the system may assist in electronically recording and monitoring pharmaceutical sample inventory maintained by the medical office upon receipt dispensing or otherwise disposing of the pharmaceutical samples.

2. Description of the Related Art

Pharmaceutical samples provided by pharmaceutical companies through their representatives to medical offices are dispensed by medical personnel to patients while visiting a doctor's office. However, these dispensed samples may not be recorded and therefore the doctors or pharmaceutical companies and representatives may not be aware of when or how quickly the samples are being depleted or when they need to be refilled. In addition, the samples may be subject to a recall, yet the doctor or medical office may not be aware of the recall and the patients who received the dispensed samples may not be contacted regarding the recall. While some systems may provide for recording contact information for pharmaceutical patients when a prescription is dispensed by a pharmacist, samples dispensed at a medical office are not typically subject to the same systems. In addition, some pharmaceutical sample tracking and monitoring systems exist which may provide for tracking of received or dispensed pharmaceutical samples. However, these systems have limitations meet in the present system, including notifying affected personnel in the event of a pharmaceutical event such as a recall, discovered adverse reactions or the expiration of the pharmaceutical sample. Therefore, it would be beneficial to provide a patient notification system, which provided a system and method for notifying a patient about a pharmaceutical event providing sample inventory tracking and monitoring systems, recording contact information about who receives the pharmaceutical sample.

Various attempts by medical offices to monitor drug samples may include using paper logs which pharmaceutical representatives write in the drug sample name, strength, quantity, lot number and expiration. Caregivers may tog when samples are removed and when samples are dispensed to patients using these paper logs. Reconciling these logs maybe difficult Different users may keep different logs for different things. In particular, the pharmaceutical representative may log samples in accordance with how they are delivered to the medical office, while caregivers may log the samples in accordance with how they are dispensed to patients including patient information like address and phone number. These logs, if maintained, are maintained separately with different logging criteria which may not be easy to match between the pharmaceutical representative and the caregiver. In addition, various state and federal guidelines and laws impose different logging criteria on the various users. Therefore, there is a need to provide patient notification system and method which maintains accurate drug sample logs, associating the sample delivered to the medical office with the sample dispensed by the caregiver to patients, allowing a drug sample to be recalled while identifying patients who received the drug sample for notification regarding the recall.

In addition, errors may occur during the recording of the drug sample delivery and dispensing. Errors in the dispensing to patients or delivery to the medical office may be life threatening and are a significant consideration for the medical office. In addition, adverse drug reactions may occur when a patient is medicated with a particular drug sample. Prompt and systematic notification of the adverse drug condition to a pharmaceutical, company may help prevent the adverse drug reaction by other patients who have also received the drug sample. Therefore, it would be beneficial to have a system: and method for reducing errors in the delivery and dispensing process while allowing for prompt and systematic notification of an adverse drug condition to the pharmaceutical company.

### SUMMARY OF THE INVENTION

In the practice of the present invention, a method and system for transmitting a message to at least one patient in response to a pharmaceutical event, the patient being associated with at least one of a plurality of pharmaceutical samples maintained by at least one medical office, the system comprising a computer in communication with a medical office database adapted for retrievably storing pharmaceutical data and a plurality of patient data, the pharmaceutical data associated with each pharmaceutical sample, the patient data being associated with a patient and stored as a patient record. Upon dispensing the pharmaceutical sample to the patient corresponding to said patient record, the computer associates the pharmaceutical data with the patient record. An event including event data is received by the computer and the message generated by the computer and transmitted to each patient associated with the pharmaceutical sample corresponding to the event data. A method of notifying a patient, of the pharmaceutical event includes configuring a patient notification system including a server in communication with a database adapted to receive a plurality of data, receiving pharmaceutical data associated with each pharmaceutical sample, retrievably storing the pharmaceutical data in a pharmaceutical record within the database, receiving patient data including a unique patient identifier corresponding to the patient retrievably storing the patient data in a patient record within the database with at least one of the patient records being associated with at least one pharmaceutical sample, receiving event data associated with the pharmaceutical event at the patient notification system, the event data corresponding to at least one pharmaceutical record, filtering the database for a list of patient records associated with the pharmaceutical event and generating a message by the server in response to the pharmaceutical event, the message transmitted to each patient within the list of patient records.

### BRIEF DESCRIPTION OF THE DRAWINGS

FIG. 1 is a schematic diagram of an overview of a pharmaceutical tracking system embodying features of the invention.

FIG. 2 is an overview block diagram embodying features of the invention disclosed in FIG. 1.

FIG. 3 is a block diagram of Supply drug sample feature embodied in the present invention.

FIG. 4 is a block diagram of Dispense drug sample feature embodied in the present invention

FIG. 5 is a block diagram of the Drug Rep Sign-in feature embodied in the present invention.

FIG. 6 is a block diagram of the Initiate Recall feature embodied in the present invention.

FIG. 7 is a block diagram of exemplary reports for use with the present invention.

FIG. 8 is a block diagram of the Create Report feature embodied in the present invention.

FIG. 9 is a block diagram of Caregiver Sign-in feature embodied in the present invention.

FIG. 10 is a block diagram of Medical Director Sign-in feature embodied in the present invention.

FIG. 11 is a block diagram of Pharmaceutical Company Sign-in feature embodied in the present invention.

FIG. 12 is a graphical user interface screen illustrating a user sign-in embodied in the present invention.

FIG. 13 is a graphical user interface screen illustrating the user recall screen for use with the recall feature embodied in the present invention.

FIG. 14 is a graphical user interface screen illustrating a Medical Director Main Menu screen embodied in the present invention.

FIG. 15 is a graphical user interface screen illustrating a user search screen for use with the search feature embodied in the present invention.

FIG. 16 is a graphical user interface screen illustrating a Pharmaceutical Company Main Menu screen embodied in the present invention.

FIG. 17 is a graphical user interface screen illustrating a Pharmaceutical Company-Representative Main Menu screen embodied in the present invention.

FIG. 18 is a graphical user interface screen illustrating create report feature embodied in the present invention.

FIG. 19 is a graphical user interface screen illustrating add inventory to medical office feature embodied m the present invention.

FIG. 20 is a graphical user interface screen illustrating alarm viewer/messaging feature embodied in the present invention.

FIG. 21 is a graphical user interface screen illustrating dispense sample to patient feature embodied in the present invention.

FIG. 22 is a graphical user interface screen illustrating remove sample from medical office feature embodied in the present invention.

FIG. 23 is a graphical user interface screen illustrating a geographic filter selection window embodied in the present invention.

FIG. 24 is a graphical user interface screen illustrating a medical office filter selection window embodied in the present invention.

FIG. 25 is a graphical user interface screen illustrating a pharmaceutical company filter selection window embodied in the present invention.

FIG. 26 is a graphical user interface screen illustrating a create report control window embodied in the present invention.

FIG. 27 is a graphical user interface screen illustrating a dispensing sample summary screen embodied in the present invention.

FIG. 28 is an alternative graphical user interface screen create report selection window.

FIG. 29 is a graphical user interface messaging screen for use in creating a new alarm message for use with the present invention.

FIG. 30 is a graphical user interface messaging screen for use in creating a response resolution message for use with, the present invention.

FIG. 31 is a graphical user interface messaging screen for use in creating a new message for use with the present invention.

FIG. 32 is a graphical user interface messaging screen for use in creating a new Adverse Drug Reaction message for use with the present invention.

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. The embodiments of the current invention shown in the attached drawings provide a system and method for drug sample inventory and tracking that allow medical offices to monitor the inventory of their drug samples, to record newly received drug samples, to record the dispensing of their drug samples, and to automatically monitor the status of received or dispensed drug samples. Optionally, the system may allow drug companies to monitor the inventory, dispensing and utilization of their drug samples at various medical offices. Therefore, specific details disclosed herein are not to be interpreted as limiting, but merely as a basis for the claims and as a representative basis for teaching one skilled, in the art to variously employ the present invention m virtually any appropriately detailed system or method.

### II. Patient Notification System and Method

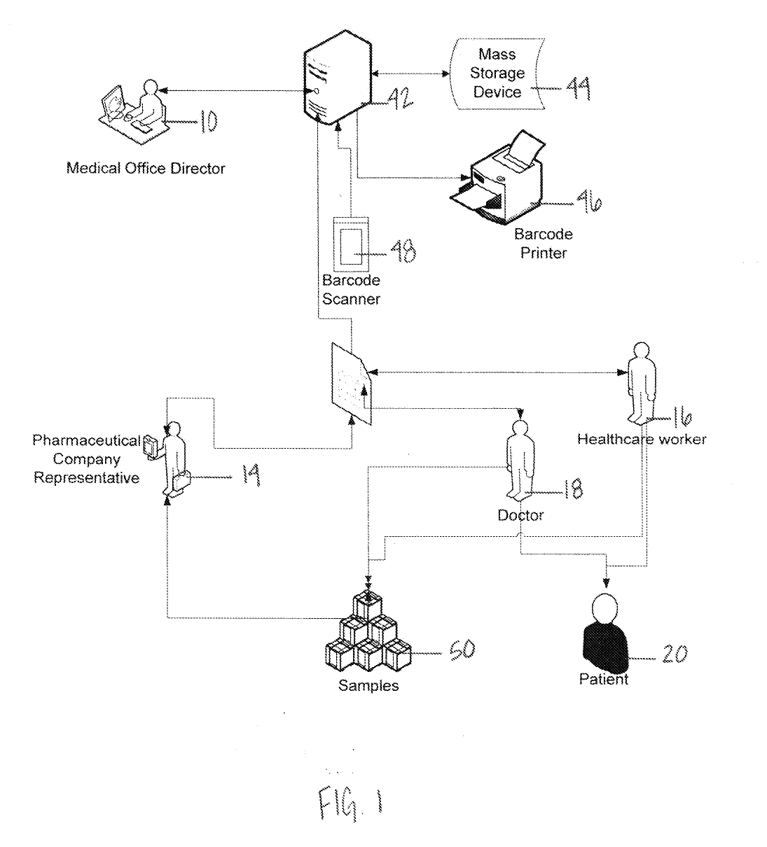

Referring to the drawings in greater detail, FIG. 1 is a schematic overview representing a patient notification system and method in accordance with a first aspect of the invention. The system illustrated in FIG. 1 is generally indicated by reference numeral 40. The system 40 for notifying a patient associated with a pharmaceutical drug sample, also referred to herein as drug sample, pharmaceutical sample or simply sample 50 includes a conventional computer 42 in communication with a mass storage device 44 for retrievable storage of electronic information. A printer 46 is also provided in association with the computer 42 as well as a barcode reader or scanner 48. In general, the computer 42 may be located at a medical office for use by medical office personnel such as medical director 10 or other configuration, medical office or system users. The computer 42, of the system 40 maybe maintained by the medical office personnel 10, a health care worker or caregiver 16 as well as pharmaceutical company personnel such as a pharmaceutical representative 14.

An inventory of drug samples 50 may be received and maintained at the medical office, for example in a secure medical closet within the medical office. The drug samples 50 are typically dispensed from the inventoried area to specific patients for medical reasons at the physician's request. During the course of dispensing the samples to patients, the drug samples 50 may become depleted. To maintain the inventory, drug samples 50 may be added to the medical office by the pharmaceutical company representative 14 or caregiver 16. When the medical office receives drug samples, they are added to the medical office drug sample inventory, pharmaceutical data associated with the drug samples 50 being electronically recorded on the mass storage device 44 through the computer 42. When the drug samples are dispensed to a patient, the healthcare worker 16 which may include a doctor 18 may deliver the drug sample 50 to a patient 20, recording the associated sample data on the mass storage device 44 using an input device in communication with the computer 42. Optionally, an input device (station) may be used for inputting pharmaceutical data associated with the drug sample 50 into the medical office computer and an optional dispensing station may be used to dispense the drug sample 50 to a patient 20. The system 40 may be configured to monitor the status of the inventory during the drug sample delivery process, including the receiving, dispensing and storage of the various drug samples 50 within the medical office, allowing the medical office personnel 10, pharmaceutical company representative 14 or pharmaceutical company to utilize the system 40 monitor a portion or all of the inventory status. During the receipt and dispensing of the inventory from the system, the inventory of drug samples reflected within the system will be adjusted whereby the inventory reflects the number of pharmaceutical samples received by the medical office and not dispensed.

The computer 42 may be used to access the mass storage device 44 which may retrievably store various system data such as drug sample data, drug sample tracking information, patient data, dispensing information and messages or alerts generated by the computer and transmitted to the patient associated with the drug sample. The computer 42 includes a processor, which is typically used with commercially available operating systems such as Microsoft UNIX or some other operating systems, the computer 42 including standard features such as internal memory, art electronic storage device, video display card, keyboard or other standard peripheral input devices and standard electronic circuitry.

The computer 42 may connect to an internal network through a standard network interface card or the computer 42 may connect to an external network or even through a global network like the internet using a secure interface protocol via a direct network connection such as a T1 line, T3 line, ISDN line or a wireless connection.

Typically, the computer 42 will be located at the medical office; however, the computer 42 may be located offsite or it may be in electrical communication with an offsite server located at a remote location for access by several medical offices or for access by the pharmaceutical company having a pharmaceutical computer networked to the offsite computer. If the system is configured with an offsite server in electrical communication with the local computer 42 located at the medical office, a portion or all of the medical office database 44 may be replicated on a server database in communication with the server for storage and backup purposes. In addition, the server database, if available, or the medical office database, may transmit a portion or all of their data to the pharmaceutical computer of the pharmaceutical company for various purposes, including recording keeping, sample status or feedback purposes.

In addition to standard peripheral devices such as a mouse, keyboard and printer, the computer 42 located at the medical office may include the barcode reader 48 for electronically reading printed barcodes associated with the received, stored or dispensed drug samples 50. The barcode reader 48 may be a handheld version, such as the commercially available Magellan® 1400i omni-directional handheld scanner, Magellan being a registered trademark of PSC, Inc.

The computer 42 may be located near a drug sample storage area such as the drug closet or another secure location, or the computer 42 may be located near a centrally located work station for access by multiple system users.

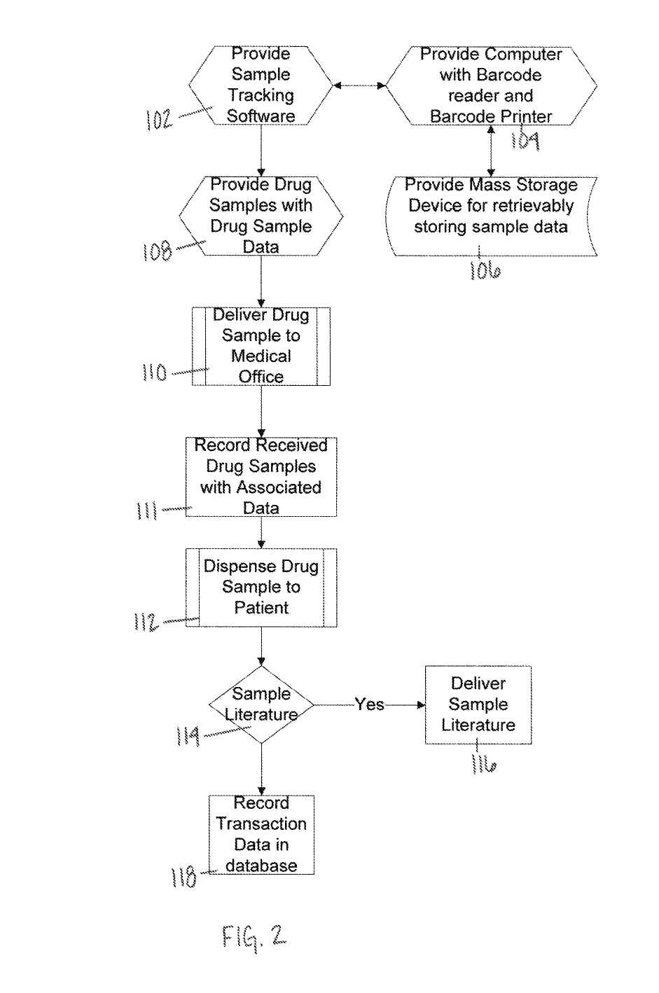

In operation, as illustrated in FIG. 2, patient notification software as further described below, may be provided 102 for use with the computer 42 having 104 the barcode reader 48 and barcode printer 46 for collecting, organizing, tracking, dispensing, printing and displaying drug sample data, printed on barcodes using the attached barcode printer 46. Drug samples 50 associated with pharmaceutical sample data, retrievably stored 106 on the mass storage device 44, may be provided 108 by a pharmaceutical company. Pharmaceutical data, also referred to herein as drug sample data or sample data, may include, but is not limited to information such as a unique drug sample identifier, lot numbers, name, strength, quantity, expiration date and number of received samples. The drug sample data is retrievably recorded 111 by the system 40. The drug samples 50 may be delivered 110 to the medical office directly by the pharmaceutical company or indirectly through a pharmaceutical company representative 14. Once received 110 by the medical office and recorded 111 by the system 40, the drug samples 50 may be dispensed 112 through the system 40 to the patient 20. Optionally, sample literature may also be provided 114 to the medical office, which is associated with the drug sample 50. If sample literature is provided, it may optionally be delivered 116 to the patient 20 during the dispensing transaction.

Once the drug sample 50 has been dispensed, the patient is generally associated with the dispensed pharmaceutical sample by associating the stored pharmaceutical sample data with the patient data. In addition, transaction data associated with the dispensing transaction is generally retrievably stored 118 on the mass storage device 44. The transaction data includes, but not limited to, patient data organized into a record, historical data including date and time specific data identity of the dispensing party and other data related to the patient, drug sample 50 or dispensing transaction.

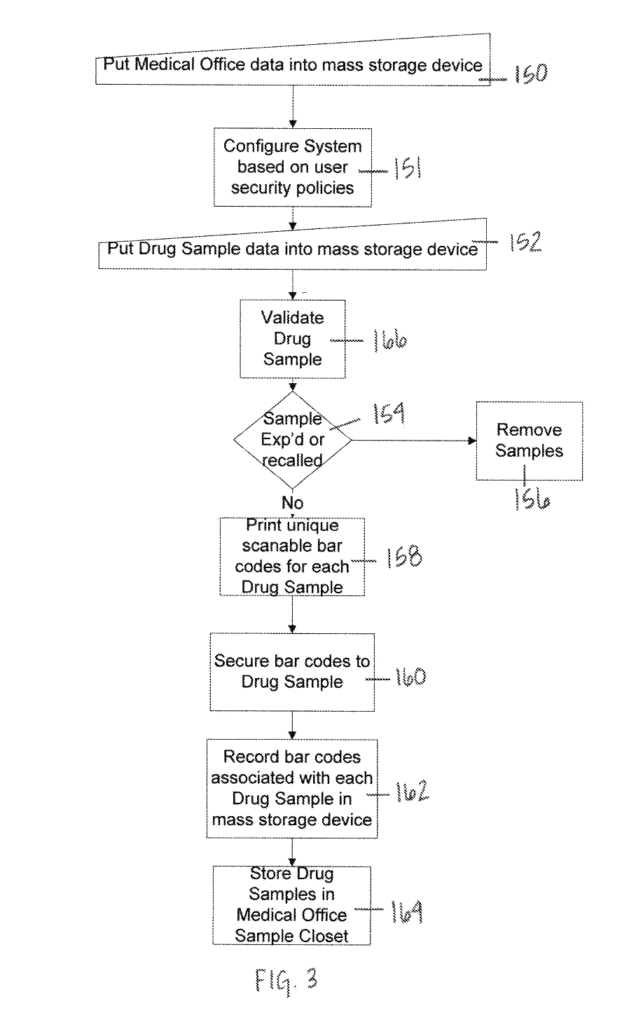

As illustrated in FIG. 3, the system may be configured by providing medical office data 150 for receipt into the system into the system 40 by the medical office for retrievable storage by the mass storage device 44 through the computer 42 and attached input device like the keyboard. Additionally, the medical office may configure 151 the system 40 based on the medical office user and/or security policies to personalize the system for each user account with various limitations and authorizations to review, initiate or monitor features of the system 40.

The user accounts may also be configured with secured access, requiring the user to provide login credentials, or optionally use biometrics such as fingerprint, hand print or other user identifying credentials. For example, US Biometrics offers several USB fingerprint scanners, including. The Q, which may be used connected to a USB port on the computer.

The medical office may also configure the user accounts such that only certain users are allowed to add or dispense the drug samples 50; including limiting dispensing to properly licensed medical personnel with optional limits on the ability to generate various system reports. However, the above referenced system configurations may also vary for each medical office utilizing the system 40 and each system user. The medical office security policy may also be adjusted such that the system 40 is in compliance with such guidelines as HIPAA, federal or state drug sampling guidelines or other medical office guidelines. Therefore, the above reference configurations are simply exemplary and as understood by those skilled in the art, the system may provide for a number of different configurations by each medical office.

Upon receipt of the drug sample 50 and associated drug sample data, the data is entered 152 into the system 40 for retrievable storage of the drug sample data by the mass storage device 44. For example, the sample data may be manually entered into the system 40, or the drug sample data may be uploaded into the system 40 with the use of various storage media having stored electronic drug sample data or from an off-site computer containing drug sample data, the off-site computer being in communication with the computer 42, for example but not as a limitation, through the internet, for retrievable storage of the drug sample data by the mass storage device 44. If the system 40 uses previously provided drug sample data, a drug sample 50 may be added to the patient notification system 40 through a selection process rather than the input device using a manual entry procedure. By way of example, according to one embodiment of the automated selection process, the user may select the appropriate sample to add to the drug sample inventory using drop down menus or scrolling text windows, in addition using the automated selection process, the system 40 may limit or verify the provided drug sample data during the above described automated selection process. Alternatively, the present patient notification system 40 may safeguard the manually provided drug sample data, during the receipt of the drug sample.

Incomplete or inaccurate data may be rejected or if the sample 50 is expired or subject to a recall 154, the system user may be prevented from entering the sample data into the system 40.

Prior to printing the barcode, the drug sample data may also be validated 166 for any errors in the data entry process. This validation process may be used to identify typographical errors in the data entry process or to validate that the sample 50 is one which the medical office is configured to dispense. If the sample 50 is subject to a recall or has expired, the sample barcode may not be generated or printed and the user may be instructed to contact or notify a pharmaceutical representative or the medical office of the recall or expiration of inventoried samples with the medical, office determining whether to and how to notify any patients in receipt of the recalled or expired, samples 50.

Because drug samples may have a limited shelf-life, the expiration of the drug sample data may be determined by comparing the drug sample expiration date of the drug sample data with the current computer date and if the expiration date has passed the system 40 may prevent the sample 50 from being added to the existing drug sample inventory. Alternatively, if any samples 50 have been previously added to inventory through the system 40, a notification flag or alarm may be generated to initiate removing the expired or recalled drug sample 156. Upon receipt of the non-expired and non-recalled drug sample 50, the system 40 may generate 158 a unique barcode for each sample 50, printing the barcode using the attached printer 46. Alternatively, the drug sample may have its own unique code affixed to the sample prior to receipt by the medical office. Once the printed barcode is associated 160 with the sample 50 and the code is recorded 162 by the system 40, the sample 50 may be stored 164 at the medical office, for example in the sample closet.

Using the automatic dialer feature, the present system 40 in communication with a telephone network may automatically call the telephone number of the patient based upon the previously stored patient data within a patient record stored on the mass storage device. The system 40 may generate an automatic audio message, notifying the patient of a pharmaceutical event such as a recalled sample, expired sample, adverse drug reaction, or other relevant pharmaceutical event. The automatic dialer feature may then transfer the call to a live operator if the patient is reached, or the automatic dialer feature may play the recorded audio message notifying the patient of the relevant event details about the pharmaceutical event, leaving a message for the patient or notifying the patient to contact the medical office or healthcare worker regarding the pharmaceutical event. The details of the pharmaceutical event may be entered directly into the automatic dialing feature as event data using the computer, or the details may be recorded by the system 40 as an audio message for playback by the system 40.

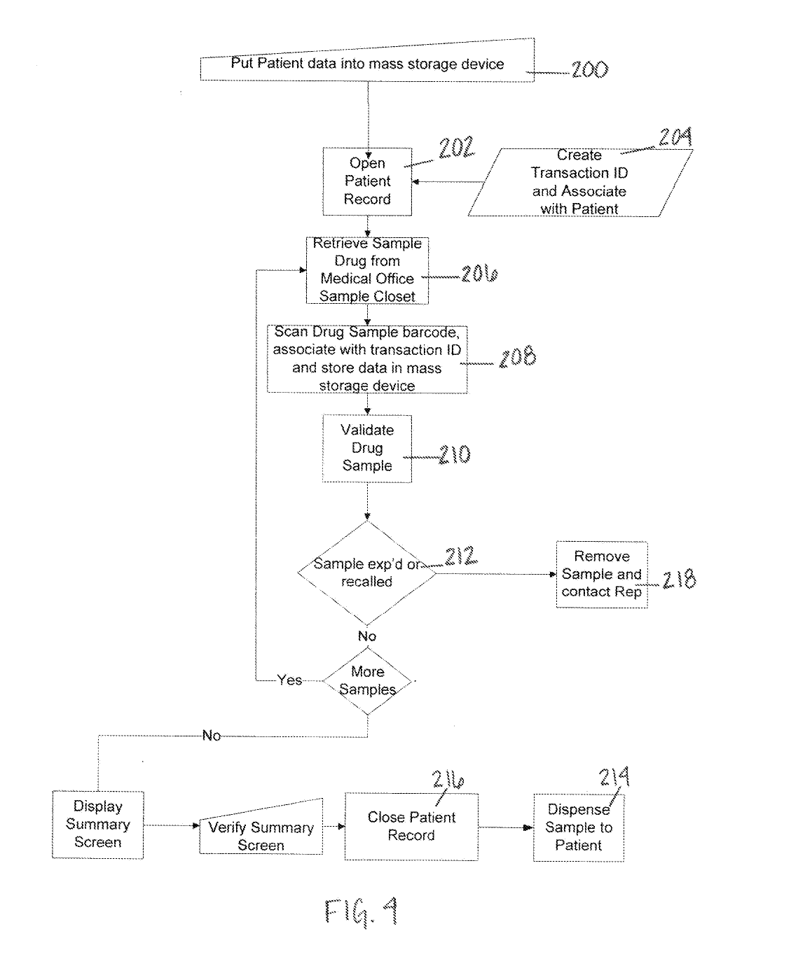

Drug samples 50, inventoried by the system 40 within the medical office drug sample closet may be dispensed to patients 20 as illustrated in FIG. 4, after patient data is entered 200 into the system 40 and retrievably stored on the mass storage device 44. In one embodiment of the dispensing process, patient data stored on the mass storage device 44 may be organized into a patient record, including confidential and non-confidential data such as, but not limited to, a unique patient identifier, patient name, patient address, patient phone number, patient email address, patient insurance carrier, patient primary doctor, patient prescriptions, prior prescriptions, prior samples, patient age, patient weight, patient height patient sex, patient allergies, patient adverse reactions and patient medical conditions. However, it will be understood by one skilled in the art that the information in the patient record could be any information that the medical office or other system users would find useful in notifying the patient of a pharmaceutical event and in tracking, monitoring and dispensing drug samples. In addition, rather than having ail of the data organized into a single patient record, patient data may be organized into a table, database or multiple databases to organize the patient data for retrievable storage within the mass storage device 44.

To help ensure the proper patient record is opened 202 and to facilitate opening the patient record, the unique patient identifier may be encoded on a barcode which may be affixed to a patient item such as a file, card, or paper and electronically read with the handheld barcode reader 48.

Upon initiating a dispensing transaction, the patient record is accessed and associated 204 with a unique transaction identifier. The drug sample 50 may then be retrieved 206 from the medical closet with the associated barcode, or other identifier, which can be scanned 208 and recorded by the computer 42 in the currently open patient record along with the transaction identifier. Once the drag sample identifier and patient identifier have been entered into the system 40, the drug sample data associated with the scanned drug sample barcode is retrieved and associated with the patient record (having plural items of patient data) of the patient 20 receiving the dispensed sample 50. The transaction identifier and drug sample identifier may then be recorded within the patient record for retrievable storage from the mass storage device 44.

As previously mentioned during receipt by the medical office, the drug sample can be validated. In addition, before dispensing the sample 50, the system 40 can validate 210 the drug sample 50 to ensure that it is not subject to a recall or that it is not currently expired 212 and that it has been properly received by the system 40. If the drug sample data has not been entered into the system 40, or if required fields are missing, the system user may be prompted to provide the missing data. By accessing the stored sample data such as the drug name, expiration date and lot number, the system 40 may determine whether the sample is valid, i.e. not subject to a recall or expired. Once validated 210, the sample 50 can be dispensed 214 to the patient 20 and if there are no more samples 50 to be dispensed 214, the patient record can be closed 216 and the transaction identifier advanced awaiting the next user transaction. By validating the drug sample 50 prior to dispensing, the invalid drug sample may be removed 218 prior to dispensing and the pharmaceutical company computer or medical office computer may be notified by the system 40.

Referring generally to FIG. 5, using the current system 40 a user such as the pharmaceutical company representative 14 or other authorized system user can quickly and easily initiate a recall 260, add drug sample inventory 262, create 264 an alert, alarm or message, perform system maintenance 266, review the system: status 268 or generate system reports 270.

The system 40 may allow the pharmaceutical company representative 14 to initiate a recall 260 after logging in 250 and provide their unique user identifier, credentials, or optionally sign-in using the attached biometrics scanner as discussed above. The unique identifier can be any unique identifier, such as the user's name, the user's social security number, an identification number which may or may not be affixed to a tangible object such as a card through a barcode or RFID chip, their fingerprint, their hand print, their retinal scan or any other unique identifier optionally in combination with a password. It will be readily understood by one skilled in the art that many different types of security method and devices exist to verify the user's identity and access to the system.

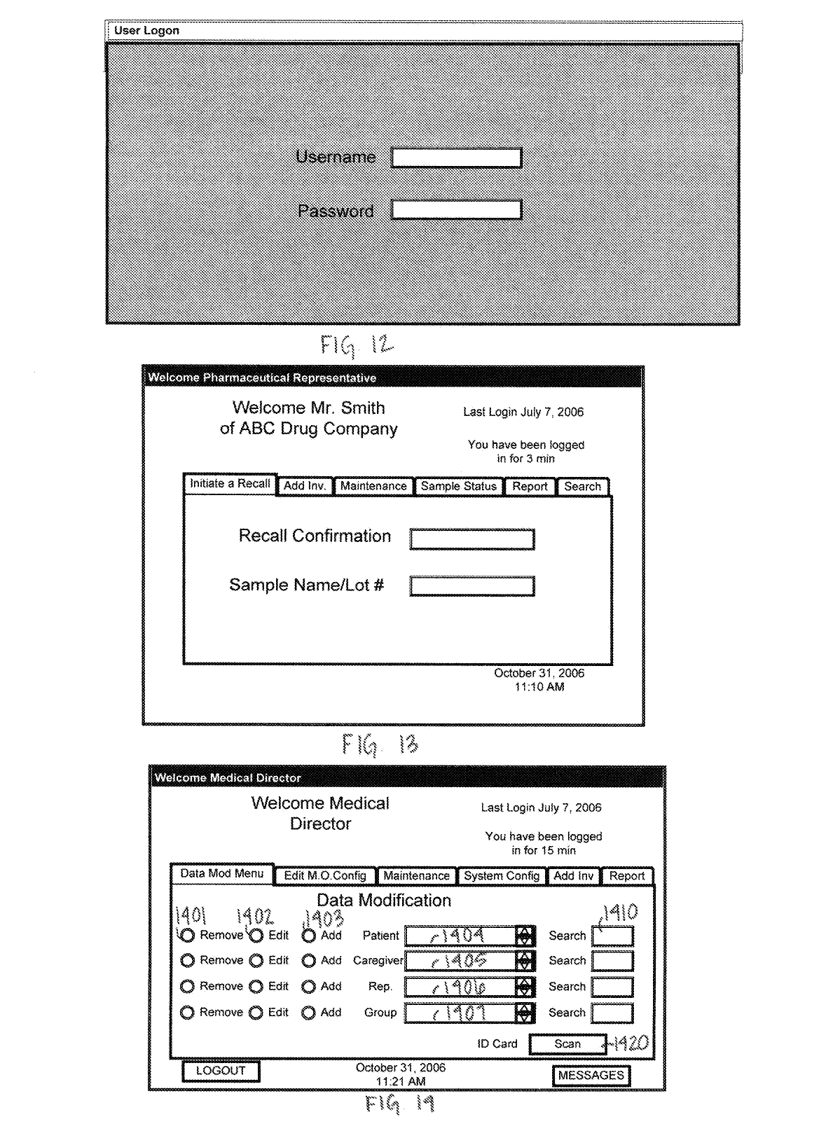

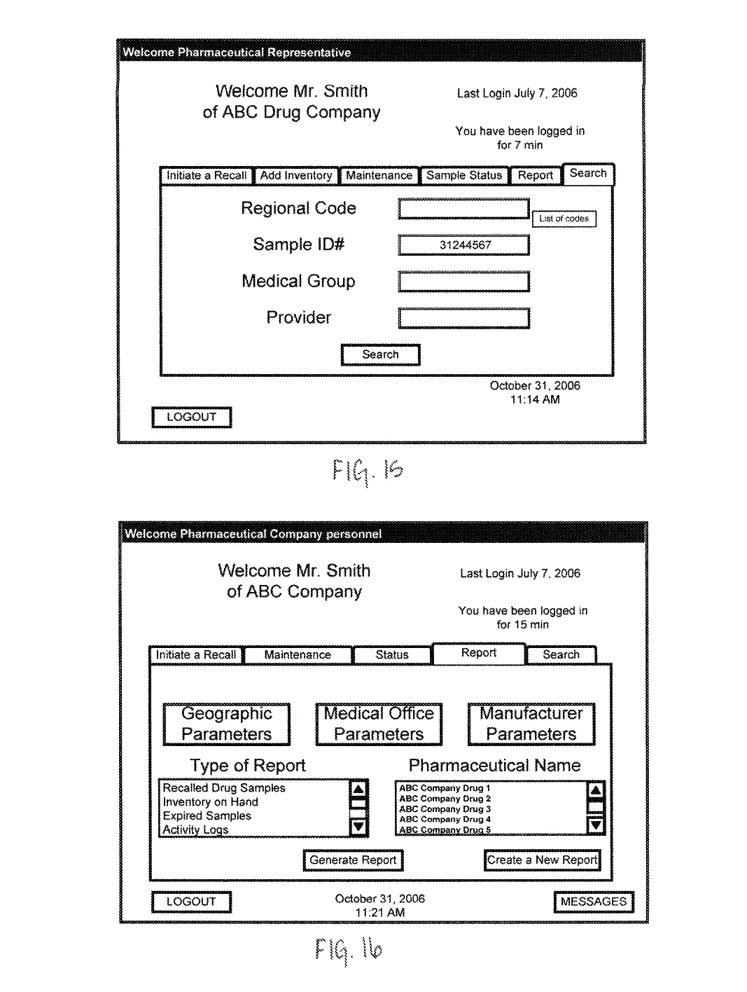

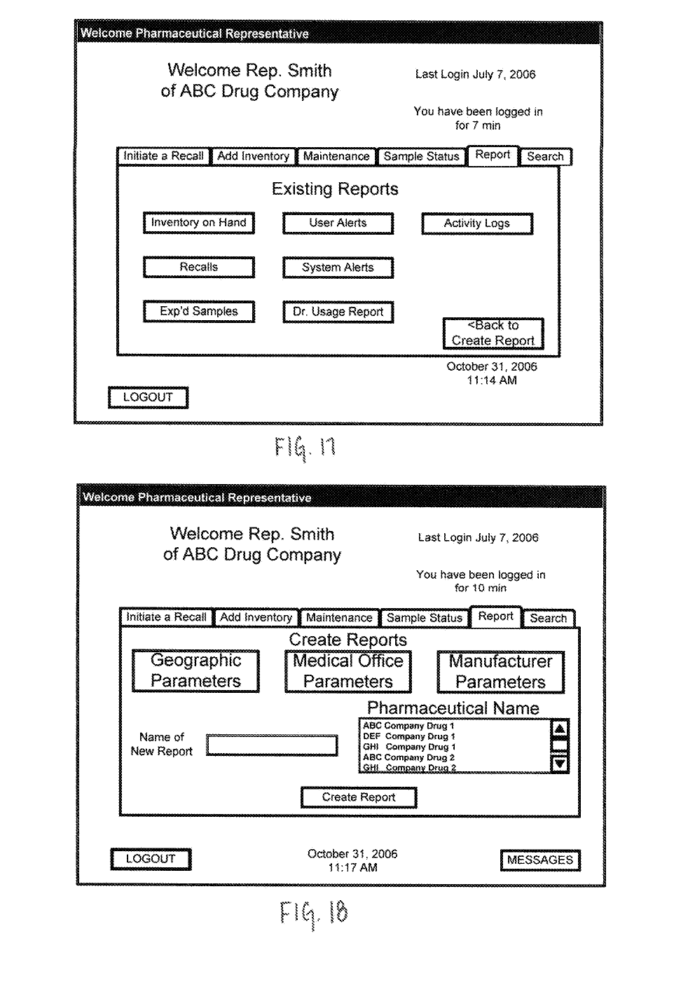

Once the representative 14 has logged 250 into the system 40, the system 40 will apply 252 the security policy or other parameters as configured by the medical office or another configuration user by comparing the supplied user identifier against the previously configured list of authorized and permitted users. If the user identifier does not match the list of configured users, the representative 14 may be informed they are not allowed to access the system 40 and they may be permitted to retry their login. If the user identifier is found, the system 40 will apply the previously configured user policies, office guidelines and display the representative's main menu screen as illustrated in FIG. 18 which will allow the pharmaceutical representative 14 to access certain features of the system 40 as configured for the representative 14 by the medical office or other configuration user.

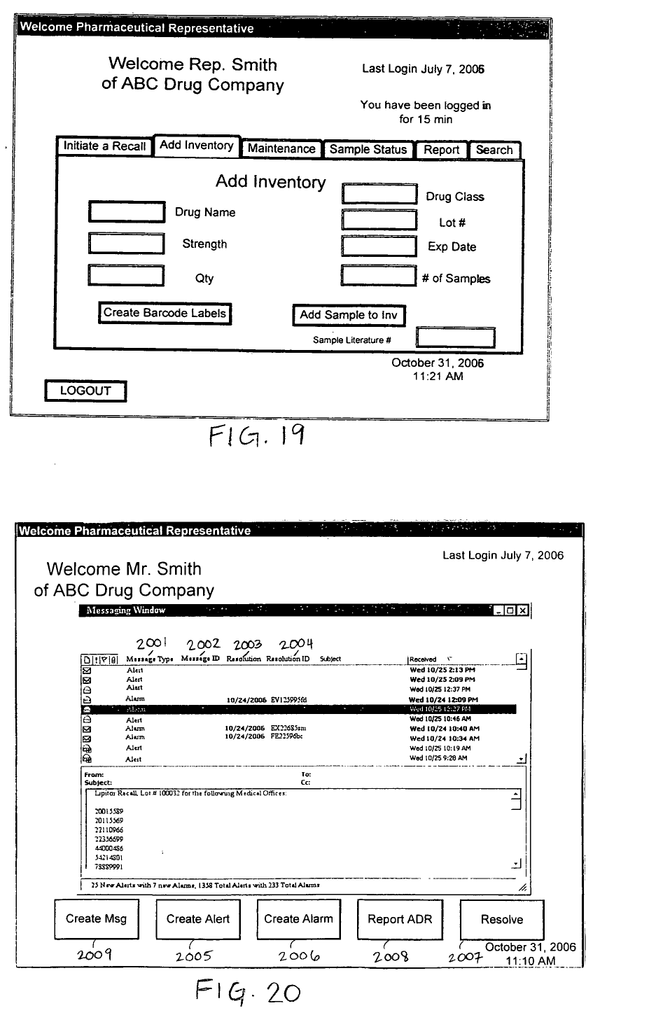

Once tire validated representative is togged into the system 40, the system 40 creates a historical event, recording the unique transaction identifier associated with the user login, if there are new alarms which the pharmaceutical company representative 14 has not acknowledge, an alarm viewer screen, like the one of FIG. 20, may be displayed by the computer monitor. Otherwise, the preconfigured pharmaceutical company representative main menu as illustrated in FIG. 18 may be displayed on the computer monitor.

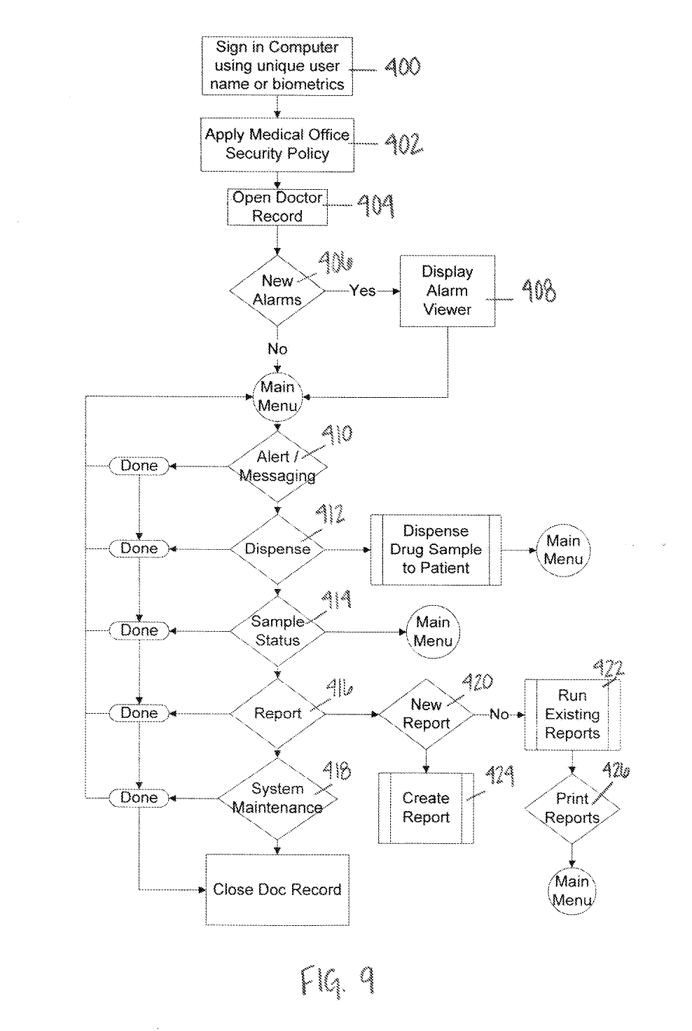

Once logged 250 into the system 40 and the security policy and/or user policy has been applied 252, the pharmaceutical representative 14 may initiate a recall 260 by providing a verification number 280, or password aid a unique drug sample identifier such as the drug sample name or lot number 282 or some combination thereof, into the recall screen as illustrated in FIG. 13.

According to the block diagram of FIG. 6, the system 40 may allow the user to choose 302 to recall the drug sample 50 by name, lot number or some combination thereof, associated with the recalled pharmaceutical sample. The system 40 may then filter 306 the retrievably stored electronic list of historical transactions by the unique identifier such as name, lot number or some combination thereof 320. By generating the filtered transaction list 304 based upon the drug sample name 306 or lot number 308, the system 40 can determine which samples 50 have been dispensed 322 to patients 20, which are still in inventory 330 and which have not been received by the system 40. If samples 50 were received by the medical office 320, entered into the system 40 by lot number or name and samples were dispensed 322, a report may be generated 324, itemizing the dispensed samples. If the received samples 50 are still in inventory 330, a report may be generated 332 itemizing the samples 50 still in inventory.

During the dispensing transaction, undispensed samples, remaining in inventory may be dispensed by the system. Dispensing of the pharmaceutical samples may be accomplished by utilizing the barcode reader 48 in communication with the computer 42, scanning 334 the barcode associated with the drug samples 50 and removing 336 the scanned samples 50 from the medical closet or other dispensing location. By scanning the barcode associated with the drug sample 50, the system 40 may identify the sample 50 including the drug sample data associated with the drug sample 50 during receipt at the medical office.

The medical office, medical director 10, caregiver 16 or other healthcare worker may receive data related to the pharmaceutical event for relevant drug samples from the system 40 in the form of a report, email, alert, message or otherwise. Based upon the pharmaceutical event data, also referred to herein as event data, the receiving system user or the system itself may contact those affected patients 20 and advise them of the recall in accordance with medical office guidelines. Once all samples 50 to be recalled 340 have been entered into the system 40, the user may logoff or they may chose another available system feature, as illustrated for example, on FIG. 18.

Referring again to FIG. 5, another system feature provides for the addition of 262 pharmaceutical samples 50 into the inventory of the system 40 by the pharmaceutical representative 14 where drug samples 50 are added 262 to the medical office sample inventory. The drug sample data associated with the received drug samples 50, may be electronically recorded, monitored and displayed by the computer 42 using a standard inventory spreadsheets such as Microsoft's Excel or using a database like Microsoft's Access or Oracle Corporation's Oracle Database or any other database inventory tracking program which can electronically track the inventory of the drug samples 50 stored and dispensed within, a medical, office. The current system 40 may be used to track the inventory of each drug sample 50 received 262, dispensed 214 and recalled 260 at the medical office and to associate the drug samples 50 having drug sample data with various items of information such as patient identifiers and transaction identifiers for each, drug sample 50 received 284 (illustrated in FIG. 5) and dispensed 214 (illustrated in FIG. 4) at the medical office.

Using the current system 40, the system 40 may record the delivery of pharmaceutical drug samples 50 by the pharmaceutical representative 14 to the medical office's inventory by delivering 284 the drug samples 50 to the medical office as illustrated in FIG. 3. Alternatively, the drug samples 50 may be delivered directly to the medical office by the pharmaceutical company and recorded by the system 40, the samples 50 being added to the drug sample inventory by the caregiver 16 or other system user.

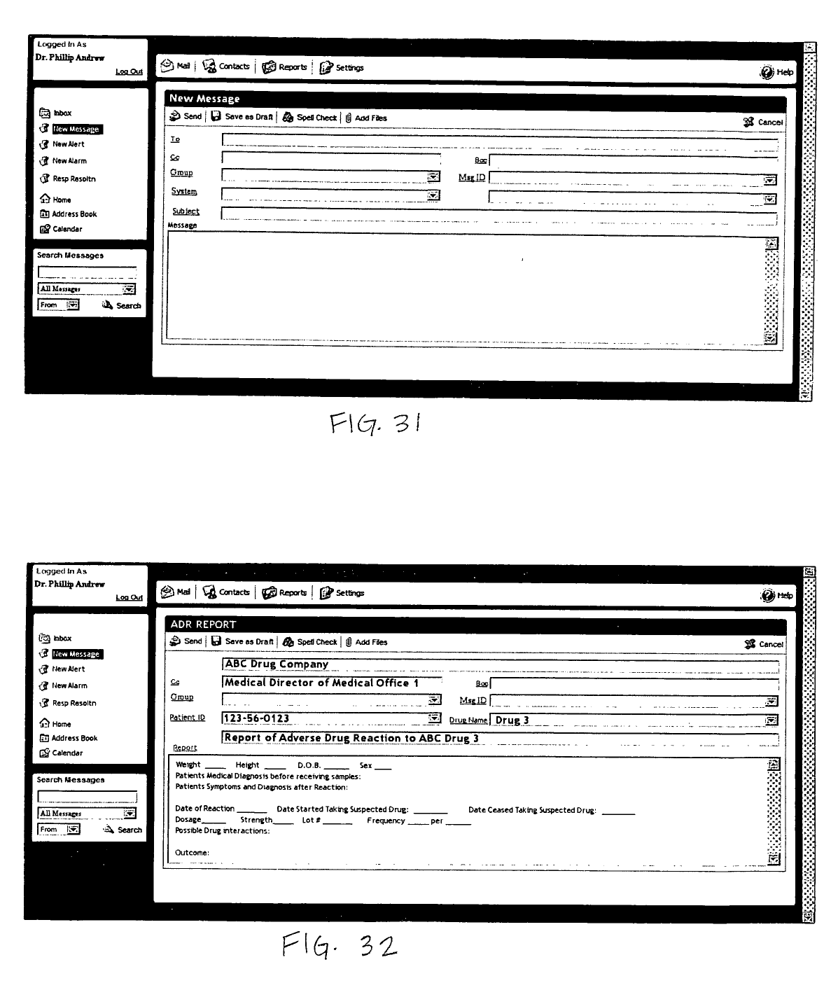

Additionally, as illustrated in FIGS. 5 and 18, the system may generate an alert, alarm, response or message 264 to other system 40 users or the system 40 may allow the pharmaceutical representative 14 to review current messages or alerts or review historical messages or alerts. A messaging window like the one illustrated in FIG. 20 may be used to review current messages and alerts. Alternatively, the system may allows the pharmaceutical representative to create a new alert, alarm, message or resolve an existing alarm with a response resolution window as illustrated in FIGS. 29-31. After creating the alert, alarm message or resolution, the system 40 may send the message via SMTP or other protocol to an individual or group of users. Alternatively, the system may generate a system wide alert alarm, response or message, for transmission to all configured system users.

As illustrated in FIG. 5, the system may also allow the pharmaceutical representative may to utilize system maintenance 266 features to install software updates, change or add contact information, perform typical computer maintenance or inventory maintenance on the system 40.

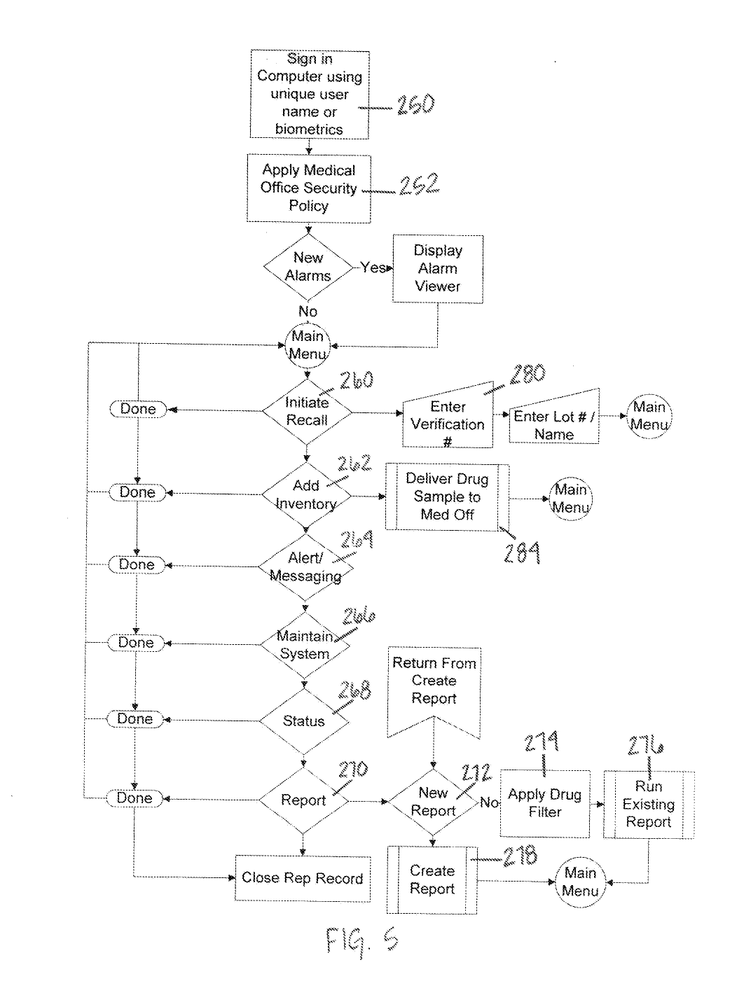

The system 40 may also allow the pharmaceutical representative 14 to review 268 the system 40 status or generate 270 various reports. In generating 270 reports, the system may allow the pharmaceutical representative to choose 272 from existing reports 276 or create 278 a new report using the reporting features of the system 40. Existing reports 276 may be selected from previously configured reports by the medical office, other system users or by a third party or from reports which may have been installed during the system configuration as part of a standardized library of reports for example. To this end, the system 40 may include pre-configured standard reports like those illustrated on FIG. 7 including, but not limited to, recalled samples 360, inventory on hand 362, expired samples 364, user alerts 366, system alerts 368, caregiver usage report 370 or historical activity logs 372. Using the preexisting report feature, the system may allows the pharmaceutical representative 14 to generate reports using the preconfigured filters applied to the historical data, retrievably stored on the mass storage device 44, like those in FIG. 7 or a custom report may be created 278 using the reporting features of the system 40 in communication with the database management software or the data within the mass storage device 44. Optionally, the data may also be exported or imported into a third party software reporting package like Business Objects' Crystal Reports or Microsoft's Access.

The generated report may be printed, emailed, faxed, displayed on the monitor, electronically transmitted from one computer to another device or electronically stored on storage media such as a removable CD-Rom, USB storage device or a fixed storage device as understood by one skilled in report generation. Once completed running reports 270, the system 40 may allow the pharmaceutical company representative 14 to return to the main menu as illustrated in FIG. 18 or exit out of the system 40.

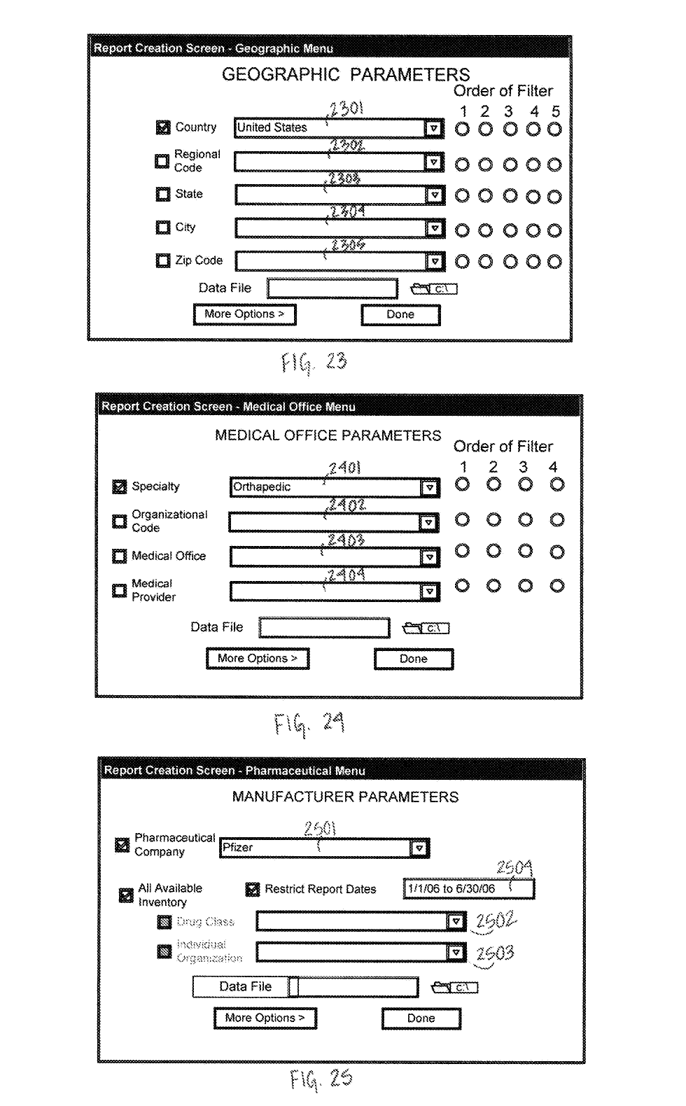

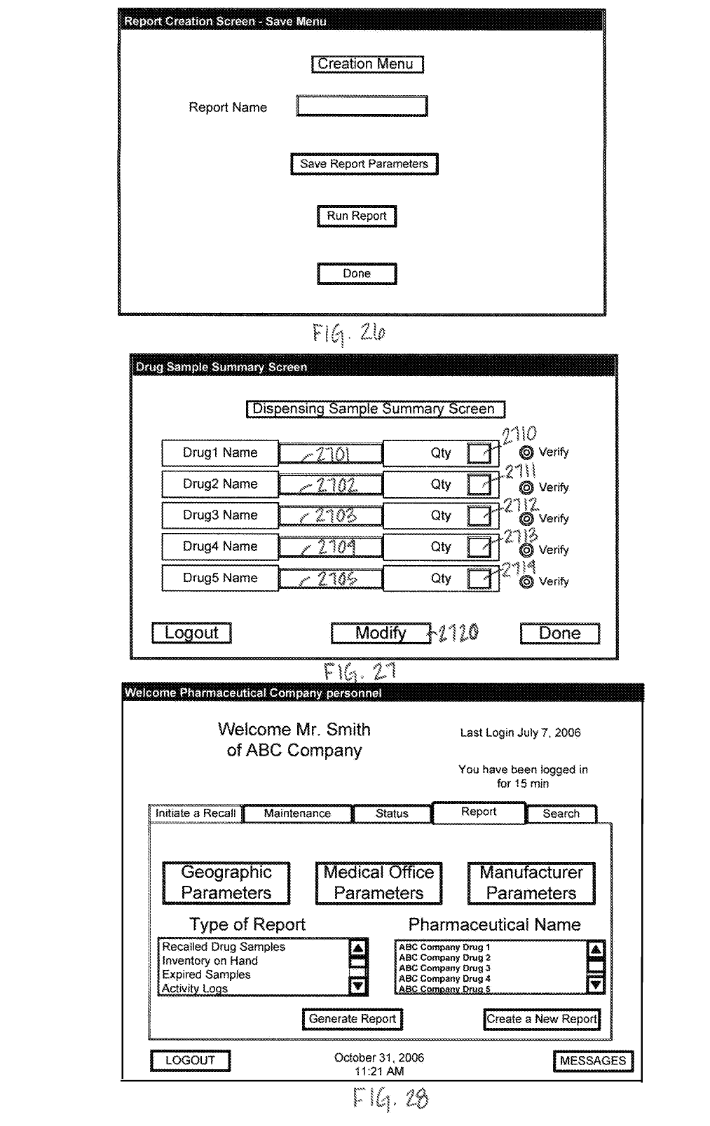

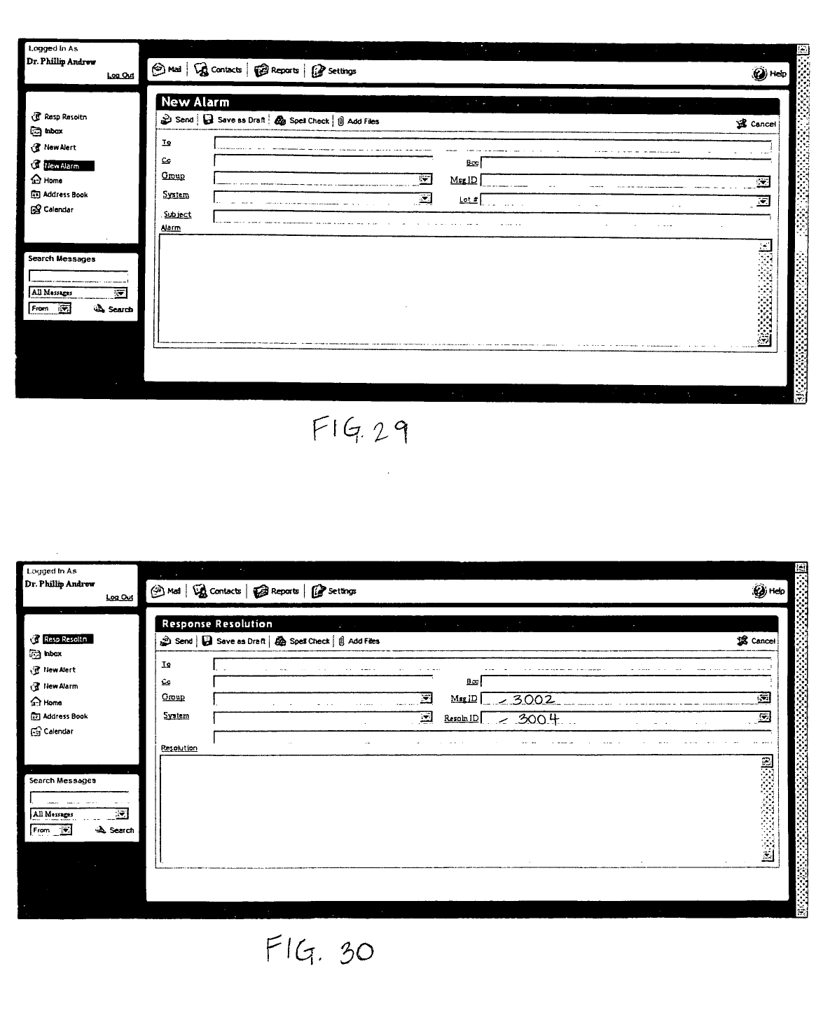

The system 40 may create a custom report as illustrated in FIG. 8, with the authorized pharmaceutical representative 14 selecting 382 which filter or plural filters to apply to the stored data 380 such as, but not limited to, the transactional, historical, patient or drug sample data. “The filters to be applied may include, but are not limited to, geographic filters 384, medical office filtering criteria 386 or pharmaceutical company filtering criteria 388. A sample of a geographic filtering selection, window is illustrated in FIG. 23 and may include criteria such as country 2301, regional code 2302, state 2303, city 2304 and zip code 2305. A sample of a medical office filtering selection window is illustrated in FIG. 24, including, but not limited to, specialty practice area 2301, organizational code 2302, medical office 2303 or medical provider 2304 criteria. FIG. 25 illustrates, a filtering selection window which may be filter the data by associated pharmaceutical company 2501, drug class 2502, organizational number 2503 or the stored data may be restricted within a certain date range 2504.

Once the pharmaceutical representative 14 has finished entering the filtering parameters, the filtering criteria may be saved for repeated use. The system 40 may generate the report by applying the filtering parameters against the stored data files such as the historical, patient or drug sample data depending on the desired report. Alternatively, the report may be generated by applying the filtering parameters to multiple data files within a single mass storage device 44 or several mass storage devices in communication with the computer 42 through a wired or wireless network, using point to point, intranet or internet networking architectures. Optionally; as illustrated in FIGS. 23-25 the filtering parameters may be prioritized between multiple filter selection windows or within a single filtering window.

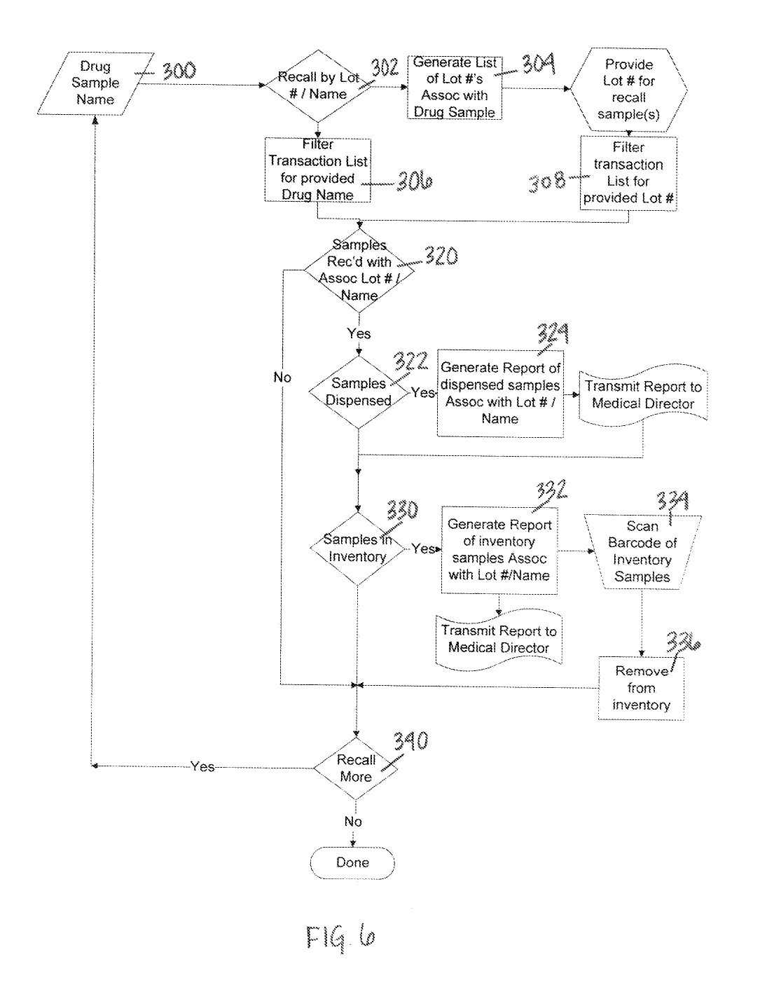

Referring to FIG. 9, the system 40 may allows the caregiver 16 or other system user to quickly and easily review or create Alerts or Messages 410, Dispense Drug Samples 412, review the Status of Drug Samples 414, Generate Reports 416 or perform System Maintenance 418.

Once the caregiver 16 or other system user has logged 400 into the system 40, the medical office security policy may be applied to the system 40 as configured by the medical office or other configuration user. Based upon the configured access, the system 40 may limit or provide access to various system features from the main caregiver menu illustrated in FIG. 21.

Comparing the caregiver 16 or other system user identifier against the previously configured list of authorized and permitted users, the system 40 may apply the applicable system 40 security. If the caregiver 16 or other system user identifier does not match the list of allowed and configured users, the caregiver 16 or other system user may be informed they are not allowed to access the system 40 and they may be permitted to re-login. If the caregiver identifier is found, the system 40 will apply the previously configured security and/or user policies. If new system alarms exist 406, which have not been resolved, the system 40 may then display 408 the alarm viewer window screen illustrated in FIG. 20. If no new alarms exist, the system 40 may display the caregiver main menu screen of FIG. 21, allowing the caregiver 16 or other system user to access certain system features as configured for the caregiver 16.

Once the validated caregiver 16 or other system user is logged into the system 40, a historical transaction identifier is generated with the system 40 recording the unique transaction identifier associated with the caregiver login. The system 40 may then display the preconfigured caregiver menu screen of FIG. 21.

Returning to FIG. 9, the system 40 may allows the caregiver 16 or other system user to sign-in 400 by providing their user credentials, or rising the attached biometrics scanner as previously discussed. The unique identifier can be any unique identifier, such as the user's name, the user's social security number, an identification number which may or may not be affixed to a tangible object such as a card through a barcode or RFID chip, their fingerprint, their hand print, their retinal scan or any other unique identifier optionally in combination with a password. It will be readily understood by one skilled in the art that many different types of security method and devices exist to verify the user's identity and access to the system.

Once logged-in, the system 40 may allow the caregiver 16 or other system user to display the alarm viewer of FIG. 20. The illustrated alarm viewer screen may indicate the message type 2001, including but not limited to, alarms or alerts and the associated unique message identifier 2002 associated with each message for referencing specific messages. In general, alarms may be associated with events requiring a higher degree of caution while alerts may have a generally lower degree of priority. Once an alarm is resolved, the system 40 may record the time/date of resolution 2003 along with an identification of the resolution message optionally created in connection with the resolution of the alarm. In this way, the resolution message can be associated with the alarm, for users to identify the cause and resolution of the system alarm.

The system 40 may also provide an alarm viewer screen as illustrated in FIG. 20, allowing the caregiver 16 or other system user to send a communication such as a message 2009, alert 2005, alarm 2006 through the messaging windows like those illustrated in FIGS. 29-31 or the caregiver 16 or other system user may resolve the alarm and indicate the response 2007 through the response resolution window as illustrated in FIG. 30. Additionally, the system 40 may allow the caregiver 16 or other system user to report 2008 an adverse drug reaction by a patient 20 to the pharmaceutical company through an ADR report window like the one illustrated in FIG. 32. In this way the caregiver 16 or other system user may inform other system users of current system needs like needed samples 50, expired samples or the adverse drag reaction.

Using the ADR report 2008 feature within the alarm viewer window of FIG. 20, the system may allow the caregiver 16 or other system user to report the patients 20 adverse drug reaction directly to the pharmaceutical company. When the report ADR feature 2008 is initiated, the ADR messaging window similar to FIG. 32 may be displayed, allowing the caregiver 16 or other system user to provide relevant information or data for notifying the pharmaceutical company. However, unlike a typical messaging window, the email address of the message may be determined by the system 40 based upon the drug sample identifier such as the name, lot number or some combination thereof, previously configured within the system 40 so that the message may be directly transmitted to the relevant pharmaceutical company. Alternatively, the ADR message may be transmitted to the medical office computer 42 for transmission to others including the system server or other third party. In addition, a copy of the ADR message may be made available to other system users.

The alert or alarm may be displayed within the alarm viewer window of FIG. 20, notifying other system users of possible drug reactions related to the drug sample 50. Upon receipt by the medical office or system, server of an ADR message, the system 40 may generate a message to be transmitted to each patient associated with the relevant drug sample 50. The ADR messaging window of FIG. 32 may include fields or a form for assisting the caregiver 16 or other system user in providing detailed ADR data. In this way, the system 40 allows for an expedited method to inform the pharmaceutical companies or others of the adverse drag reaction using an electronic, at least partially automated, standardized format.

A messaging review window of FIG. 20, may allow the caregiver 16 or other system, user to review current messages, alarms and alerts. Alternatively, the system 40 may allow the caregiver 16 or other system to create a new alert 2005, alarm 2006 or message depending on, for example, whether the information to be sent requires action (alarm) or is for informational purposes only (alert or message). After creating the alert 2005, alarm 2006 or message, the system 40 may allow the caregiver 16 or other system user to select various system users to receive the alert, alarm or message. Alternatively, the system 40 may provide for a system wide message, alert or alarm or depending on the system configuration, grouped recipients may receive the alert, alarm or messages.

Alternatively as illustrated in FIG. 9, the system 40 may allow the caregiver 16 or other system user to dispense 412 the drug sample 50 to patient 20 as illustrated in FIG. 4. In general, the system 40 may have patient data associated with a medical office patient electronically stored 200 along with pharmaceutical data associated with a pharmaceutical drug sample 50. As is generally understood, the patient data may be organized within the database 44 as records, the patient record being generally associated with the medical office patient. During the dispensing transaction, the system 40 may electronically access 202 the patient record, generate die transaction identifier 204 and associate the current transaction with the data contained within the accessed patient record. The sample 50 may be retrieved 206 from the drug sample medical closet or other location and then dispensed 214. If the pharmaceutical sample 50 includes the optional barcode, the barcode of the sample 50 maybe scanned 208 with the barcode reader 48, facilitating the identification of the sample 50 by the system 40, the pharmaceutical data being generally associated or recorded with the presently accessed patient record. After identifying the dispensed sample 50, the system 40 may decrease the sample 50 from the inventory of the medical, office.

As illustrated in FIG. 21, the system 40 may assist the dispensing of the drug sample 50, through a two step process by allowing the caregiver 16 or other system user to input 2101 the patient, identifier or otherwise identify the patient receiving the sample 50 and scanning 2102 the barcode associated with the pharmaceutical sample 50. Upon scanning 2102 the sample barcode, the system 40 may automatically populate the drug name 2104, the drug strength 2106, the quantity 2108, the drug sample expiration date 2110 and lot number 2112 displayed within the dispense sample transaction screen of FIG. 21. The pharmaceutical sample 50 may then be dispensed 2114. Alternatively, multiple pharmaceutical samples 50 may be dispensed using the sample summary screen illustrated in FIG. 27, in which multiple drug names, 2701, 2702, 2703, 2704, 2705 along with the quantity of each to be dispensed 2710, 2711, 2712, 2713, 2714 are displayed. Using the screen of FIG. 27, the caregiver 16 or other system user may verily the summary data or modify 2720 the scanned data to insure the system 40 records correct data within the associated patient record.

The change in inventory may he recorded using a standard inventory spreadsheet such as Microsoft's Excel or using a database like Microsoft's Access or Oracle Corporation's Oracle Database or any other database inventory tracking program which can track the inventory of the drug samples 50 stored and dispensed within the medical office. The inventory software is used to track the inventory of each drug sample received, dispensed and recalled at the medical office and to associate the drug sample with various items of information such as patient identifier and transaction identifier for each drug sample 50 dispensed by the caregiver 16.

The caregiver 16 or other system user may dispense 412 the drug sample 50 as illustrated in FIG. 4 or the caregiver 16 or other system user may desire to review the status 414 of drug samples 50, for example, but not as a limitation, review the number of samples 50 received in inventory or dispensed, including the quantity of drug samples in stock, dispensed, expired, recalled or a historical breakdown of the samples by pharmaceutical company or dispensed by the selected caregiver 16.

Additionally, the caregiver 16 or other system user may choose to review or generate a system report 416 by either running 422 existing reports or creating 424 custom reports. If the caregiver 16 or other system user chooses to run 422 an existing report, the caregiver 16 or other system user may chose from a list of preconfigured reports. By way of example and not as a limitation, the system 40 may be configured prior to installation at the medical office, by the medical office, other configuration users or by a third party at the time the system 40 is installed or at a later time with standard reports such as those illustrated in FIG. 7 including, Recalled Samples 360, Inventory on Hand 362, Expired Samples 364, User Alerts 366, System Alerts 368, Caregiver Usage Report 370 or reports reviewing the Activity Logs 372. Alternatively, the caregiver 16 or other system user may create 424 their own custom report using the reporting features of the system 40 with the database management software or by accessing the data contained within the mass storage device 44 and exporting or importing the data into a third party software reporting package like Business Objects' Crystal Reports or Microsoft's Access. The generated 426 report may be printed, emailed, faxed, displayed on the monitor or electronically stored on the storage media like a removable CD-ROM, USB storage device or a fixed storage device as understood by one skilled in report generation. When the caregiver 16 or other system user is done with the reporting features of the system 40, they may return to the main menu as illustrated in FIG. 21 or they may exit out of the system 40.

To create a custom report as illustrated in FIG. 8, the caregiver 16 or other system user can create a report by selecting 382 a filter or plural filtering criteria applied to the stored data 380 such as, but not limited to, historical patient or pharmaceutical sample data stored on the mass storage device 44. The filters to be applied may include, but are not limited to, geographic filters 384, medical office filtering criteria 386 or pharmaceutical company filtering criteria 388. A sample of the geographic filtering selection window is illustrated in FIG. 23 and may include criteria such as country 2301, regional code 2302, state 2303, city 2304 and zip code 2305. A sample of the medical office filtering selection window is illustrated in FIG. 24, including filtering criteria such as, but not limited to, specialty practice area 2301, organizational code 2302, medical office 2303 or medical provider criteria 2304. A sample of the pharmaceutical company filtering selection window is illustrated in FIG. 25 including, but not limited to, pharmaceutical company 2501, drug class 2502, organizational number 2503 or the stored data may be restricted within a certain date range 2504.

Once the caregiver 16 or other system user has finished entering the filtering parameters, the filtering criteria may be saved. The report may be generated by applying the filtering parameters against stored data files such as historical, patient or drug sample data or a combination thereof Alternatively, as illustrated in FIGS. 23-25, the filtering parameters may be prioritized across multiple filler selection windows or within a single filtering selection window.

System maintenance 418 features may be utilized by the caregiver 16 or other system, user including installing software updates, changing or adding contact information, adding or modifying the patient data or performing typical computer maintenance or inventory maintenance on the system 40.

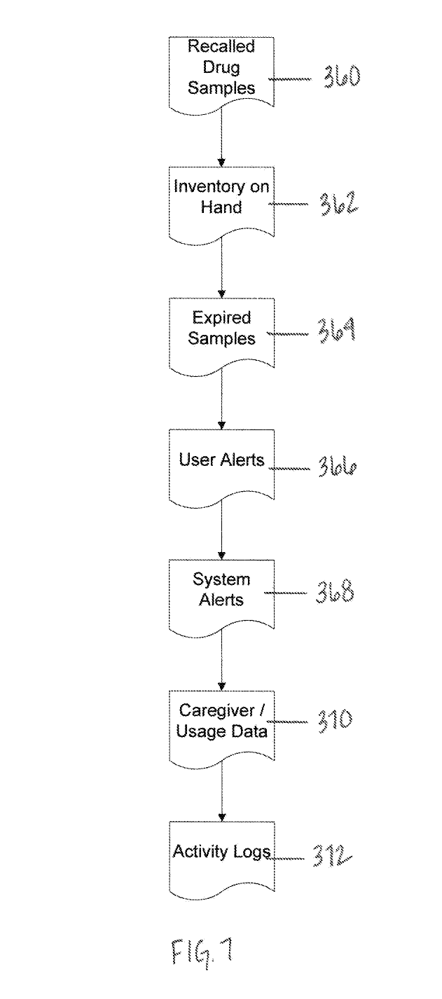

Referring to FIG. 10, using the current system 40, the Medical Director 10 or other system, users can choose 454 between adding 400, editing 458 or removing 456 data, or performing system maintenance 500, configuring 502 the system, editing 508 medical office configuration parameters or utilizing the reporting 504 features of the system 40 including creating 510 a new report or running 512 an existing report.

Once the Medical Director 10 or other system user has logged into the system 40 the medical office's security policy may be applied to the system 40 based on the supplied medical director parameters and as configured by the medical office or other system users to determine if and what the Medical Director 10 can access by comparing the Medical Director's unique identifier against the previously configured list of authorized and permitted users. If the Medical Director's identifier does not match the list of configured users, the Medical Director 10 may he informed they are not allowed to access the system 40 and they may be permitted to retry to login. Once the Medical Director is logged in, the system 40 may apply the previously configured user policies and bring up the Medical Director's main menu screen, as illustrated in FIG. 14 which will allow the Medical Director 10 to access certain features of the system 40 as configured for the Medical Director 10.

Once the validated Medical Director 10 or other system user is logged into the system 40, the system 40 creates a historical event, recording the unique transaction identifier associated with the Medical Director login 450, allowing the Medical Director 10 or other system user to view its preconfigured menu screen of FIG. 14. The Medical Director Main Menu screen of FIG. 14, may allow the removal 1401, editing 1402 or addition of a patient 1404, caregiver 1405, pharmaceutical representative 1406 or a user group 1407. Alternatively, the medical director 10 or other system user may search for a specific patient, caregiver or representative data record to modify, add or remove. The medical director 10 or other system user may also search for a record associated with a group of users to modify, add or remove.

The Medical Director 10 may sign-in to the system 40 by providing their user credentials, or optionally sign-in using the attached biometrics scanner as discussed above. The unique identifier can be any unique identifier, such as the user's name, the user's social security number, an identification number which may or may not be affixed to a tangible object such as a card through a barcode or RFID chip, their fingerprint their hand print, their retinal scan or any other unique identifier optionally in combination with a password. It will be readily understood by one skilled in the art that many different types of security method and devices exist to verify the user's identity and access to the system.

As illustrated in FIG. 10, adding 460, editing 458 or removing 456 data may involve adding, editing or removing Patient Data 462,464,466, Doctor Data 468, 470, 472, Caregiver Data 474, 476, 478, Pharmaceutical Representative Data 474, 476, 478, or Medical Office Data 508. For example, as illustrated in FIG. 14 the medical director 10 may remove patient data by typing the name of the patient in the patient identifier field 1404 or the patient record may be searched 1410. Alternatively, a scan able patient identifier, such as, barcode, patient ID card, bracelet or another uniquely identifiable, tangible object, may be affixed for scanning 1420 the unique identifier into the system 40 using an optional scanning device connected to the computer or the network, like the barcode scanner 48. Once the patient record is retrieved, the patient data may be modified or new data may be added to the system 40. Optionally, the Medical Director 10 may add 486, edit 488 or remove 490 a User Group using the grouping features of the system 40 for associating multiple users together based on the medical office policies and procedures.

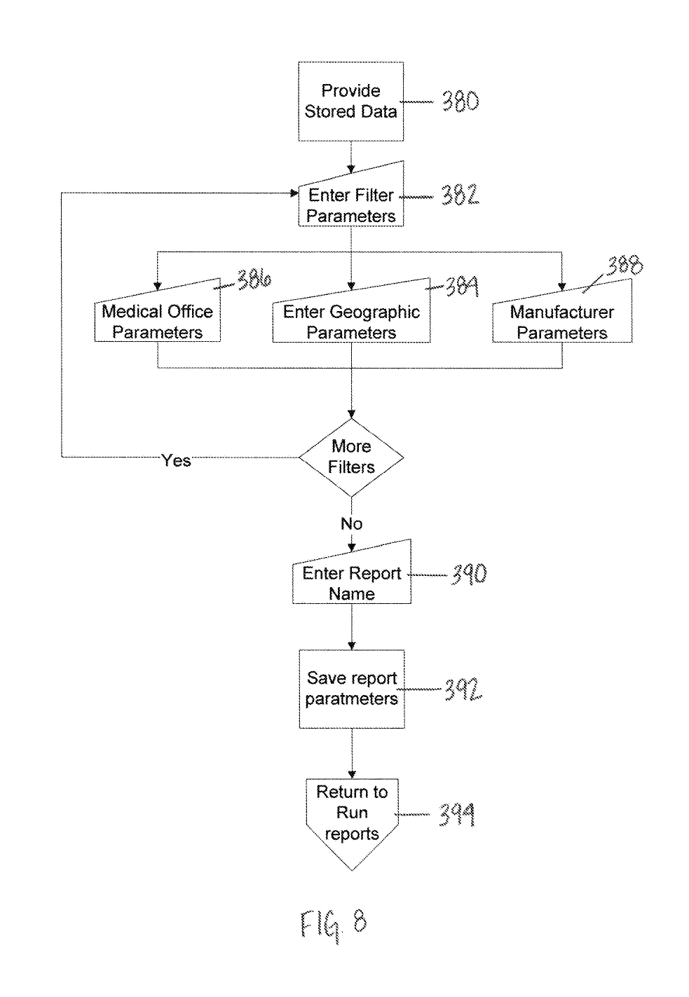

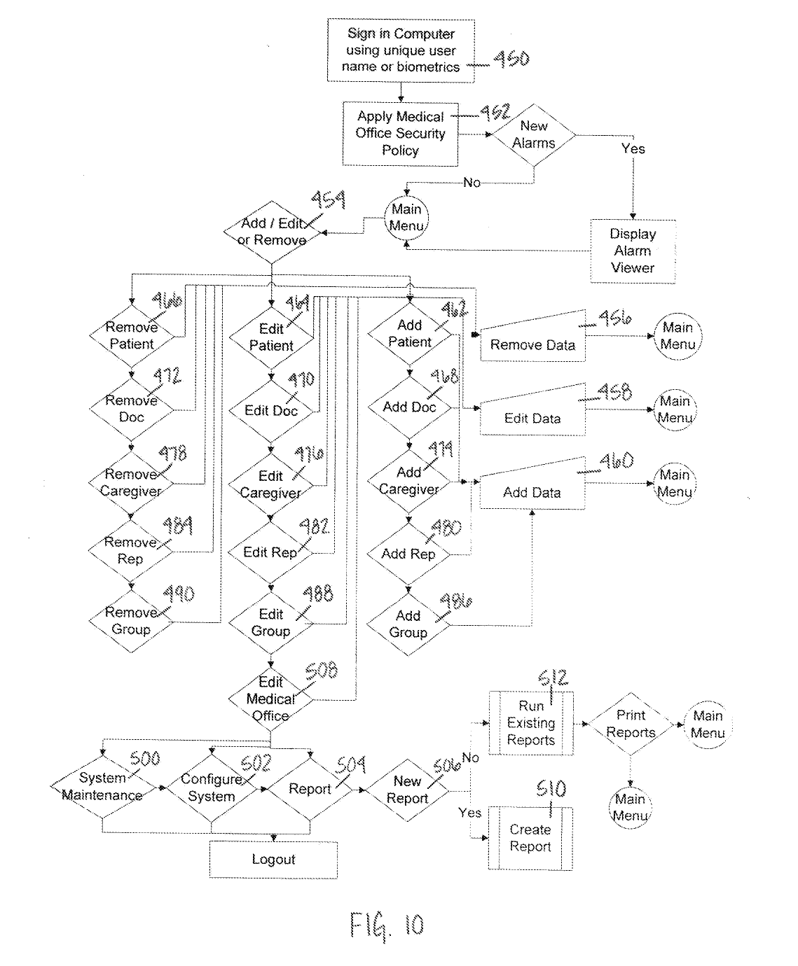

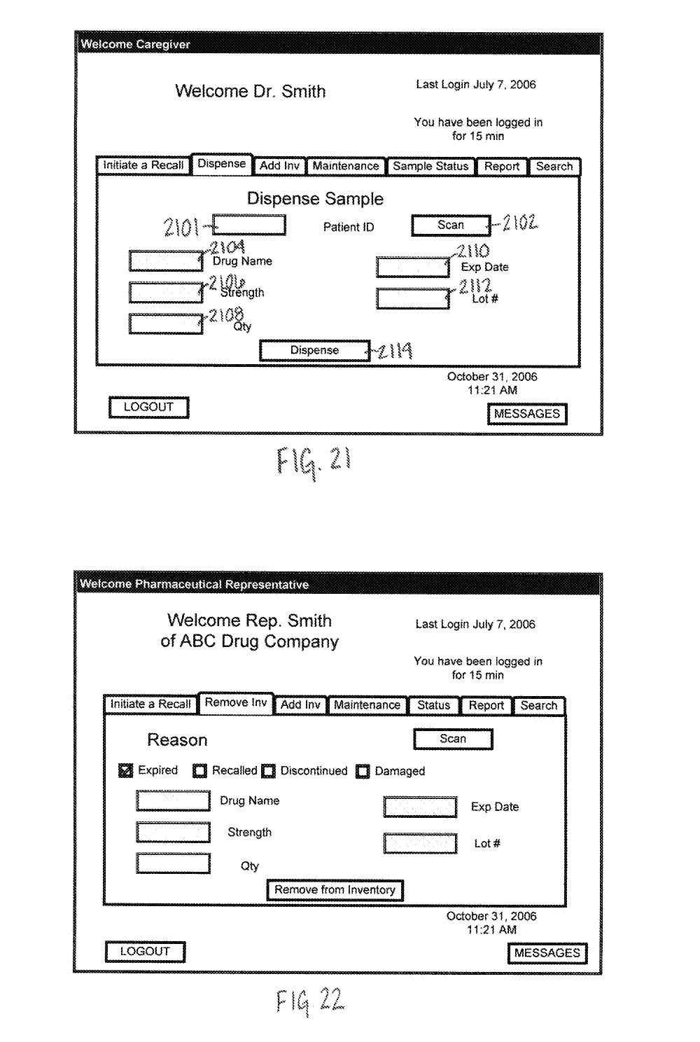

The medical director 10 or other system user may also add, edit or remove 486, 488, 490 user groups. Grouping various users together may be helpful for sending a message to one type of user rather than manually selecting each user to receive the message. For example, it may be useful to send all doctors 18 an alert notifying them of a product recall, this may be accomplished by sending the alert to all members of a user group created for doctors. In addition, the system 40 may be configured by creating configuration parameters for each user type and simply adding a new user to the system 40 and identifying the user type for configuring the user's access, security, menu, reporting and other configurable system parameters. Additionally, it may be useful to configure navigational screens, such as those illustrated in FIGS. 12-32 for various user groups rather than to create the navigational screens for each individual user. By configuring the screens for each user type rather than for each user, tire screens can be replicated easily with customization done after populating adding the user to the system and identifying the group which the user will be associated with. By creating user groups, the Medical Director 10 or other system user may also easily and repeatedly create 486 or add new members or users to the system 40 using existing configuration templates with data configured for the member of the user group, without the need to individually create all system features for each group member each time a new user is added to the system 40.

In general the Medical Director 10 or other system user may add, edit or remove 460, 458, 456 data by accessing the data or database stored on the mass storage device 44 and organizing the data, for example, into records for each patient, caregiver, pharmaceutical representative, drug sample, drug type, medical office, medical director, pharmaceutical company or other user members.

Generally, the information stored within the mass storage device 44 could be any information which a user may decide is useful to retrievably store, such as but not limited to, the unique patient identifier, patient name, patient address, patient phone number, patient insurance carrier, patient primary doctor, patient prescriptions, prior prescriptions, prior samples, patient age, patient weight, patient sex, patient allergies, patient adverse reactions and patient medical conditions. Additionally, pharmaceutical company information associated with a particular drug sample 50 may also be stored such as, but not limited to, company name, company address, company phone number, company contact company login credentials, company samples, company literature, names of company representatives, company representatives identification, company representatives phone number, company representative's address, company representative visits, company representative's login credentials, medical office contact information, medical office contacts, computer user contacts, computer user names, computer use login credentials. Medical Office information may also be retrievably stored including, medical office address, medical office staff authorization level, medical office inventory, medical office dispensed medications and historical activity or transactional logs. However, it would be understood by one skilled in the art that the information retrievably stored on the mass storage device 44 may be modified or customized depending on the needs or desires of the medical office or other users.

In an alternative embodiment, plural medical offices may be connected together with separate computers using the same mass storage device 44 connected to a single computer in communication with each separate computer or the medical offices may be connected together with plural mass storage devices 44 each being networked together, where the data may be shared between the mass storage devices and/or the computers. Although, those skilled in the art would understand that various network configurations could be utilized with the present invention, one way to connect plural medical offices together would be to provide a central computer at one location which is remotely connected to another computer at a remote location. The computer could be connected by a communications network such as a LAN, WAN, or over the internet using TCP/IP Using a client-server computer configuration between the two computers, the remote computer would be configured as a client to the central computer, which may be configured as the server using standard communication software with file upload and download capabilities such as MS Access with Internet Synchronization with the Replication Manager add-m, WS_FTP Professional software available from IPSWITCH, or Internet Explorer with file upload and download capabilities available from Microsoft Corporation. The client software is generally any web based software which may include those previously mentioned, above, Internet Explorer by Microsoft Corporation, Netscape Navigator by Netscape or Mozilla Firefox from Mozilla Foundation, or any other standard web based software.

The communications software may operate in combination with the communicating computers' respective operating systems and network interface cards to implement Internet Protocol (“IP”) network connections and Transmission Control Protocol (“TCP”), Hyper Text Transfer Protocol (“HTTP”) or file transfer protocol (“FTP”) to exchange data from various documents including web documents using Hypertext Transfer Markup Language (“HTML”) documents, plain text documents, graphic images, spreadsheets, database fields, database files. Extensible Markup Language (“XML”) documents, or other documents as necessary or desired. In this way the system 40 may receive data from each of the networked computers for retrievable storage on the mass storage device 44, for exchange of data between the networked computers, and for report generation not only at the local level, but also at the network level, providing combined information for all locations which are networked together through the networked computers.

In addition to connecting plural Medical Offices together to share the same data, a Pharmaceutical Company may be added to an alternative embodiment of the system 640 to share and provide additional data and to provide messages and/or alerts to the system 40. A pharmaceutical company computer may be added to the network, the computer including a processor, hard drive, video display card, a printer, standard features such as, but not limited to an operating system, input devices, such as keyboard, mouse and the like and a standard network interface card for networked connectivity between pharmaceutical company's computer and the system 640.

Referring to FIG. 11, in accordance with an alternative embodiment the present system 640 may allow a pharmaceutical company user to access 654 the system 640 and initiate a relevant pharmaceutical event such as but not limited to, initiate a recall 656, review or generate 658 an alert, alarm or message, maintain 660 the system, determine 662 the status and generate or create 664 a report.

Once the Pharmaceutical Company user has logged into the system 640 with a unique identifier, the system 640 will determine if and what the Pharmaceutical Company user will have access to as configured by the medical office or another configuration user by comparing the Pharmaceutical Company user identifier against the previously configured list of authorized and permitted user identifiers. If the Pharmaceutical Company user identifier does not match the list of configured users, the Pharmaceutical Company user may be informed they are not allowed to access the system 640 and they may be permitted to retry to login. If the Pharmaceutical Company user identifier is found, the system 640 will apply the previously configured user policies and bring up the user menu screen illustrated in FIG. 16 which will, allow the Pharmaceutical Company user to access certain features of the system 640 as configured for the Pharmaceutical Company user. Alternatively, the pharmaceutical company user may be directed to the alarm viewer screen of FIG. 20 if new alarms exist.

Once the validated Pharmaceutical Company user is logged into the system 640 the system 640 creates a historical, event; recording the unique transaction identifier associated with the Pharmaceutical Company user login, displaying the preconfigured menu screen of FIG. 16.

The Pharmaceutical Company user may sign-in to the system 640 by providing their user credentials, or optionally sign-in using the attached biometrics scanner as discussed above. The unique identifier can be any unique identifier, such as the user's name, the user's social security number, an identification number which may or may not be affixed to a tangible object such as a card through a barcode or RFID chip, their fingerprint, their hand print, their retinal scan or any other unique identifier optionally in combination with a password. It will be readily understood by one skilled in the art that many different types of security method and devices exist to verify the user's identity and access to the system,

As further illustrated in FIG. 11, once logged into the system 640, the system 640 may initiate 656 a recall, or other pharmaceutical event, when the Pharmaceutical Company user selects the recall initiation feature 656, providing a confirmation/verification number 666 to verify the initiation 666 of the recall and providing 668 the drug sample data and associated pharmaceutical event data including for example, a recalled drug sample unique identifier like the lot number, drug sample name or some combination thereof as illustrated in FIG. 6. The system 640 may then generate a list of medical offices which have data corresponding to the pharmaceutical event data, including those which have received pharmaceutical samples associated with the recalled samples.

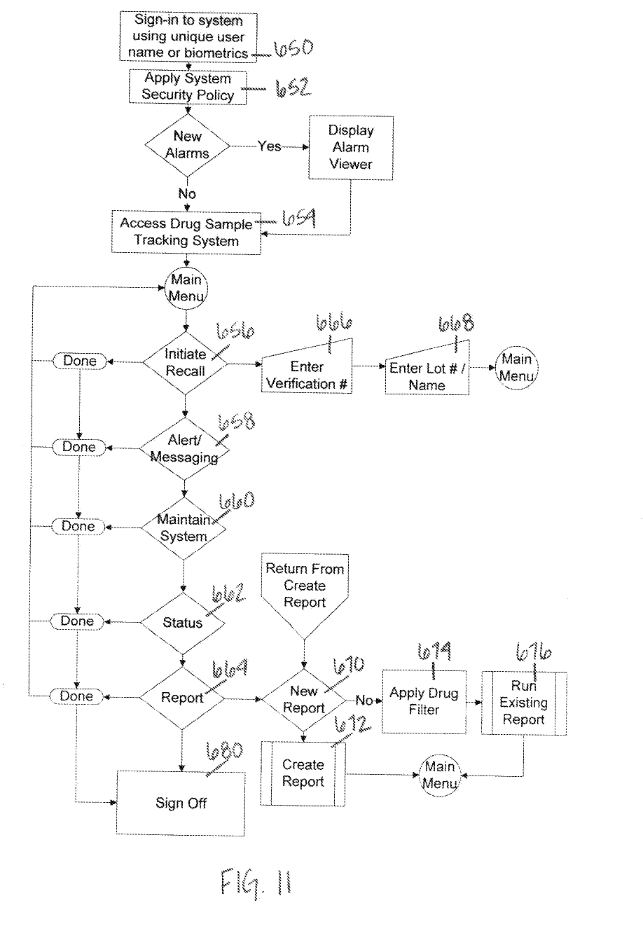

If any undispensed samples remain in the inventory of the medical office or plural medical offices, the Pharmaceutical Company user may generate an alert/message 658 or the system. 640 may generate an alert/message to each medical office along with relevant pharmaceutical event data for identifying the relevant recalled samples, to each medical office which has received the recalled pharmaceutical sample. If samples associated with, the recall have been dispensed through a medical office, the system 640 may generate an alert/message or the Pharmaceutical Company user may contact the medical office associated with the dispensed recalled pharmaceutical sample requesting that they notify affected patients 20. The medical office may then notify affected patients associated with the pharmaceutical sample based upon the associated patient data, advising the patients 20 of the recall notice pursuant to the medical office recall procedure, policy or guidelines. Once all samples 50 to be recalled by the Pharmaceutical Company have been entered into the system 640, the Pharmaceutical Company user may logoff or they may chose another menu item from those available on the various tabs of the main menu illustrated on FIG. 17.

The system may also send a communication such as a message, alert or alarm to other system 640 users by allowing the Pharmaceutical Company user to choose to review or generate an alert, alarm or message as illustrated in FIG. 29-31. FIG. 30 illustrates a response resolution, window, which may be generated in response to a previously generated alarm. After a message or alarm associated with a pharmaceutical sample event is generated, a message response including message response data may be transmitted to the system 640, and retrievably stored within said database. The response resolution window may include the corresponding message identification 3002, indicating which alarm was resolved, and a response resolution 3004 identifier. Once the response resolution window is generated, the system 640 may retrievably store the response data associated with the alarm message identifier 3002 along with the date the response is resolved within the mass storage device for display within the alarm messaging window of FIG. 20. The response data may be transmitted to a pharmaceutical company server associated with the pharmaceutical, event. The system may also allow the Pharmaceutical Company user to inform other system users of current system 640 needs such as, but not limited to, the availability of new pharmaceutical drug samples 50 or to notify the medical office of expired or recalled samples 50, through the system 640. A messaging review window, like the one illustrated in FIG. 20 may be provided to review current messages, alarms, alerts and responses. Alternatively, the system may allow the Pharmaceutical Company user to create 658 a new alarm 2006, alert 2005 or message 2008 depending on, for example, whether the information requires action or if the information is for informational purposes only, the former being an alert 2005 or message 2008 the later being an alarm 2006. After creating the alert, message, alarm, the system 640 may allow the Pharmaceutical Company user to select which system users receive the alert, alarm or message or may allow the Pharmaceutical Company user to generate a system wide message, alert or alarm, or optionally select multiple users or groups within the system 640 to receive the alert, alarm or message depending on the configuration parameters supplied by the medical office or other configuration user.

The system 620 may also allow the Pharmaceutical Company user to use the report features 670 of the system including the option to have the system 640 run 676 an existing report or create 672 a custom report. If the system generates an existing report 676, the system may provide the Pharmaceutical Company with a list of preconfigured reports from which to select such as, but not limited to. Recalled Samples 360, Inventory on Hand 362, Expired Samples 364, User Alerts 366, System Alerts 368. Caregiver Usage Report 370 or Activity Logs 372 as illustrated in FIG. 7. In general, however, the system 640 will limit the pharmaceutical company user to generating or reviewing usage or historical information to samples associated with the pharmaceutical company. The system 640 may also allow the Pharmaceutical Company user to create a custom report 672 using the filtering features of the system 640 with the database management software or by accessing the data contained within the mass storage device 44 and exporting or importing the data into a third party software reporting package like Business Objects' Crystal Reports or Microsoft's Access. The generated report may be printed, emailed, feed, displayed on the monitor or electronically stored on the storage media like a removable CD-ROM, USB storage device or a fixed storage device as understood by one skilled in report generation. When the Pharmaceutical Company user is done running 676 reports, they may return to the main menu as illustrated in FIG. 16 or they may exit 680 out of the system 640.

To create a customized report as illustrated in FIG. 8 the system 640 may allows the Pharmaceutical Company user to select 382 a filter or plural filtering criteria to apply to the stored data 380 such as, but not limited to, the transactional, patient or drug sample data. The filters to be applied may include, but are not limited to, geographic filters 384, medical office filtering criteria 386 or pharmaceutical company filtering criteria 388. A sample of geographic filtering selection window is illustrated in FIG. 23 and may include criteria such as country, regional code, state, city and zip code. A sample of a medical office filtering selection window is illustrated in FIG. 24, including, but not limited to, specialty practice area, organizational code, medical office or medical provider criteria. A sample of the pharmaceutical company filtering selection window is illustrated in FIG. 25 including, but not limited to, pharmaceutical company, inventory class, drug class, organizational number or limiting the filtering of the stored data within a certain date range. In general, however, it is anticipated that one Pharmaceutical Company will not be provided with access to another pharmaceutical company's information.

Once the filtering parameters have been provided, the filtering criteria may be saved using the Creation Menu pop-up screen of FIG. 26. The system 640 may then generate the report by applying the selected filtering parameters against the stored data files such as the transactional, patient or drug sample data depending on the desired customized report. Alternatively, the report may be generated by applying the filtering parameters against multiple data files. Optionally, as illustrated in FIGS. 23-25 the filtering parameters may be prioritized between multiple filter selection windows or within a single filtering window.

The system 640 may also allow the pharmaceutical company to utilize System maintenance features 660, including installing software updates, changing or adding contact information, adding or modifying the Pharmaceutical Company data or performing typical computer maintenance or inventory maintenance.

It is to be understood that the invention can be embodied in various forms, and is not to be limited to the examples discussed above. Other components and configurations can be utilized in the practice of the present invention.

Having thus described the invention, what is claimed as new and desired to be secured by Letters Patent is:

1. A system for notifying a patient by transmitting a message to at least one patient in response to a pharmaceutical event, the patient being associated with at least one of a plurality of pharmaceutical samples maintained by at least one medical office, said system comprising:
a computer in communication with a medical, office database adapted for retrievably storing pharmaceutical data and a plurality of patient data, said pharmaceutical data associated with each pharmaceutical sample, said patient data associated with a patient and stored as a patient record,
said computer associating said pharmaceutical data with said patient record upon dispensing said pharmaceutical sample to the patient corresponding to said patient record,
an event received by the computer including event data, and
said message generated by the computer and transmitted to each patient associated with the pharmaceutical sample corresponding to said event data.

2. The system for notifying a patient of claim 1 further comprising;
a server in communication with a system database, said server in communication with said computer,
said server receiving at least a portion of said medical office database including said
pharmaceutical data for retrievably storage within said system database, and
said event being received by said server and transmitted to said computer.

3. The system for notifying a patient according to claim 2 further comprising:
a plurality of medical offices, each computer in communication, with said server, and
a list of medical offices generated by said server in response to said event whereby said list of medical offices includes medical offices having pharmaceutical data corresponding to said event data, said event being transmitted to each medical office within said list.

4. The system for notifying a patient according to claim 2 further comprising;
a plurality of medical offices, each computer in communication with said server,
said pharmaceutical data including a pharmaceutical company identifier,
a pharmaceutical company server associated with said pharmaceutical company identifier in communication with said server,
said server selectively transmitting at least a portion of said system database to said pharmaceutical company server, and
said pharmaceutical company server generating and transmitting said event to said server.

5. The system for notifying a patient according to claim 1 further comprising an input, station in communication with said computer and having an input device for receiving pharmaceutical data associated with pharmaceutical samples received by said medical office, said pharmaceutical data retrievably stored within said medical office database.

6. The system for notifying a patient according to claim 5 wherein said computer validates said pharmaceutical data received by said input station.

7. The system for notifying a patient according to claim 1 further comprising a dispensing station in communication with said computer, said dispensing station associating said pharmaceutical data corresponding to the pharmaceutical sample to said patient record associated with the patient receiving said pharmaceutical sample.

8. A method of notifying a patient of a pharmaceutical event, comprising the steps of:
A. Configuring a patient notification system including a server in communication with a database adapted to receive a plurality of data,
B. Receiving pharmaceutical data associated with each pharmaceutical sample, retrievably storing said pharmaceutical data in a pharmaceutical record within said database,
C. Receiving patient data including a unique patient identifier corresponding to the patient, retrievably storing said patient data in a patient record within said database with at least one of said patient records being associated with at least one pharmaceutical sample,
D. Receiving event data associated with a pharmaceutical event at said patient notification system, said event data corresponding to at least one pharmaceutical record,
E. Filtering said database for a list of patient records associated with said pharmaceutical event: and
F. Generating a message by said server in response to said pharmaceutical event, said message transmitted to each patient within the list of patient records.

9. The method of notifying a patient of a pharmaceutical event of claim 8 wherein said step E filters the database according to patient records associated with pharmaceutical data corresponding to said event data.

10. The method of notifying a patient of a pharmaceutical event of claim 8 further comprising the steps of:
G. Receiving message response data corresponding to receipt of said transmitted message associated with said pharmaceutical sample event,
H. Retrievably recording said message response data within said database; and
I. Transmitting said message response data to a pharmaceutical server associated with said pharmaceutical sample event.

11. The method of notifying a patient of a pharmaceutical event of claim 8 further comprising the steps of:
G. Receiving each pharmaceutical sample at a medical office, each pharmaceutical sample being associated with the corresponding pharmaceutical record retrievably stored within said database,
H. Adjusting an inventory of pharmaceutical samples in response to said receiving step G,
I. Dispensing at least one pharmaceutical sample from said inventory to at least one patient, and
J. Adjusting said inventory according to said dispensing step (I), whereby said inventory reflects the number of pharmaceutical samples received by said medical office and not dispensed.
